(19) United States
(12) Patent Application Publication
(10) Pub. No.: US 2016/0141605 A1
(43) Pub. Date: May 19, 2016

(54) TRANSITION METAL HYDROXY-ANION ELECTRODE MATERIALS FOR LITHIUM-ION BATTERY CATHODES

(71) Applicants: Candace CHAN, Phoenix, AZ (US); Ran ZHAO, Mesa, AZ (US)

(72) Inventors: Candace Chan, Phoenix, AZ (US); Ran Zhao, Mesa, AZ (US)

(21) Appl. No.: 14/899,962

(22) PCT Filed: Jun. 20, 2014
(86) PCT No.: PCT/US14/43468

§ 371 Date: Dec. 18, 2015

Related U.S. Application Data
(60) Provisional application No. 61/837,434, filed on Jun. 20, 2013.

(51) Int. Cl. H01M 4/139; H01M 4/58; H01M 10/0525

(52) U.S. Cl. CPC H01M 4/139; H01M 10/0525; H01M 4/5825; H01M 2220/20; H01M 2220/30

(57) ABSTRACT

A transition metal hydroxy-anion electrode material for lithium-ion battery cathodes includes the charge-neutral structure Mₓ(OH)ₙ(XO₄)ₘ, where M is one or more transition metals, x is the total number of transition metal atoms, X is sulfur or phosphorus, and x, n, and m are integers. The polyanion material has a nanostructured morphology. (OH)ₙ(XO₄)m is a hydroxysulfate or hydroxyphosphate, and M can be one or more (e.g., a solid solution of) transition metals selected from the group consisting of copper, iron, manganese, nickel, vanadium, cobalt, zinc, chromium, and molybdenum. A lithium-ion battery may have a cathode including Mₓ(OH)ₙ(XO₄)ₘ as a cathode material, and an electronic device may include a lithium-ion battery having a cathode including Mₓ(OH)ₙ(XO₄)ₘ as a cathode material.

### CROSS-REFERENCE TO RELATED APPLICATION

This application claims priority to U.S. App. Ser. No. 61/837,434 entitled “Transition Metal Hydroxy-Anion Electrode Materials for Lithium-Ion Battery Cathodes” and filed on Jun. 20, 2013, which is incorporated by reference herein in its entirety.

### TECHNICAL FIELD

This invention relates to transition metal hydroxy-anion electrode materials for lithium-ion battery cathodes.

### BACKGROUND

FIG. 1A depicts lithium-ion battery (LIB) 100 having anode 102 and cathode 104. Anode 102 and cathode 104 are separated by separator 106. Anode 102 includes anode current collector 108 and anode material 110 in contact with the anode collector. Cathode 104 includes cathode current collector 112 and cathode material 114 in contact with the cathode collector. Electrolyte 116 is in contact with anode material 110 and cathode material 114. Anode material 110 and electrolyte 116 are generally known in the art. Anode current collector 108 and cathode current collector 112 are electrically coupled via closed external circuit 118. Anode material 110 and cathode material 114 are materials into which, and from which, lithium ions 120 can migrate. During insertion (or intercalation) lithium ions move into the electrode (anode or cathode) material. During extraction (or deintercalation), the reverse process, lithium ions move out of the electrode (anode or cathode) material. When a LIB is discharging, lithium ions are extracted from the anode material and inserted into the cathode material. When the cell is charging, lithium ions are extracted from the cathode material and inserted into the anode material. The arrows in FIG. 1A depict movement of lithium ions through separator 106 during charging and discharging. FIG. 1B depicts device 130 including LIB 100. Device 130 may be, for example, an electric vehicle, an electronic device (e.g., a portable electronic device such as a cellular telephone, a tablet or laptop computer, etc.), or the like.

High capacity and high rate LIBs with low cost and improved safety characteristics constitute a major requirement for electric vehicles, portable electronics, and other energy storage applications. Year-to-year electrochemical performance improvements in LIBs are typically limited to 3-4%, with a major bottleneck being the lack of appropriate materials to satisfy the energy and power density requirements. Progress in nanostructured anodes has significantly improved the potential of the practically achievable capacity and rates. For example, high capacity anodes such as silicon, which have been studied since the 1980s, have been found to overcome structural degradation problems through the use of nanowire morphologies. However, batteries utilizing silicon anodes can still only achieve a 30% gain in energy density due to the low capacity of the cathode: current cathodes have practical capacities of 150-180 mAh/g. While nanostructuring of existing cathodes has been found to lead to improvements in usable charge capacity and result in higher rate performance, the theoretical capacities of existing materials is still too low.

### SUMMARY

Transition metal hydroxyl anion materials including Mₓ(OH)ₙ(XO₄)ₘ, in which M is a transition metal (e.g., Cu, Fe, Mn, Ni, V, Co, Zn, Cr, Mo, and solid solutions thereof), x is the total number of transition metal ions, X is S or P (such that the anion is a hydroxysulfate or hydroxyphosphate), and x, n, and m are integers, are described for use in lithium-ion battery cathodes. These transition metal hydroxysulfate and hydroxyphosphate anions demonstrate improved performance as cathode materials based at least in part on characteristics such as (i) an open framework or layered structure that facilitates fast lithium ion insertion; (ii) beneficial bonding characteristics such as edge-sharing MO₆ octahedra for good electronic conductivity and improved rate performance; (iii) flexibility in alkali and transition metal cation incorporation, which can allow for the design of solid-solutions to enhance structural stability, capacity, and reaction potentials; and (iv) possibility for multielectron redox reactions due to the incorporation of more than one transition metal per formula unit, which can result in capacities exceeding 200 mAh/g.

In a first general aspect, an electrode for a lithium-ion battery includes a polyanion material including Mₓ(OH)ₙ(XO₄)ₘ, where M is one or more transition metals, X is sulfur or phosphorus, and x, n, and m are integers, and the polyanion material has a nanostructured morphology. In a second general aspect, forming an electrode for a lithium-ion battery includes preparing a composition including a polyanion material including Mₓ(OH)ₙ(XO₄)ₘ, and contacting the composition with a current collector to form the electrode.

Implementations may include one or more of the following features. The electrode including the polyanion material may be a cathode for a lithium-ion battery. M may be selected from the group consisting of copper, iron, manganese, nickel, vanadium, cobalt, zinc, chromium, molybdenum, and any combination thereof. In some cases, M is a solid solution of two or more transition metals selected from the group consisting of copper, iron, manganese, nickel, vanadium, cobalt, zinc, chromium, and molybdenum. In certain cases, M includes at least two transition metals or x is at least 2. The polyanion material may be a hydroxysulfate or a hydroxyphosphate. The polyanion material may have edge-sharing octahedra and a non-tavorite structure. The polyanion material may include LiₐMₓ(OH)ₙ(XO₄)ₘ, where a is an integer. In general, a polyanion material for an akali-ion battery includes AₐMₓ(OH)ₙ(XO₄)ₘ, where A is an alkali metal (e.g., Na, Li, K) and a is an integer.

In some implementations, the polyanion material has a nanoplate morphology. The polyanion material may be synthesized by a process including combining a base, a metal salt, and a structure directing agent such as a surfactant or polymer. Suitable structure directing agents include surfactants (e.g., cetyl trimethylammonium bromide (CTAB), sodium dodecyl sulfate (SDS), sodium dodecylbenzenesulfonate (SDBS), docusate sodium salt, oleic acid, oleylamine, and the like) and polymers (e.g., polyvinylpyrrolidone, polyethylene oxide, polyethylene glycol, polyethyleneimine, polymethyl methacrylate, and the like). The ratio of the number of moles of metal in the metal salt to the number of moles of the structure directing agent may be between 1:1 and 1:100. In some cases, nanoplate morphology of the polyanion material is achieved by a synthesis process including microwave-assisted hydrothermal treatment of a composition including a metal salt and a base.

In certain implementations, a lithium-ion battery includes the electrode of the first general aspect and/or the second general aspect. The lithium-ion battery further includes an anode and an electrolyte in contact with the anode and the cathode, as generally known in the art. In some cases, the lithium-ion battery electrode has a capacity of at least 200 mAh/g. In certain implementations, a device (e.g., an electronic device) includes a lithium-ion battery including the electrode of the first general aspect and/or the second general aspect, or any implementation thereof.

These general and specific aspects may be implemented using a device, system or method, or any combination of devices, systems, or methods. The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1A depicts a lithium-ion battery (LIB). FIG. 1B depicts a device including a LIB.

FIG. 2A shows plots of potential (vs. Li/Li⁻) versus capacity (mAh/g) for the reaction of Cu₂(OH)PO₄ (libethenite) with lithium as described in Example 1. FIG. 2B shows a scanning electron microscope (SEM) image of commercially available Cu₂(OH)PO₄ powder. FIG. 2C shows an X-ray diffraction pattern of Cu₂(OH)PO₄ nanorods.

FIG. 3A shows plots of potential (vs. Li/Li) versus capacity (mAh/g) for the reaction of Cu₄(OH)₆SO₄ (brochantite) with lithium as described in Example 2. FIG. 3B shows an SEM image of Cu₄(OH)₆SO₄ particles. FIG. 3C shows an X-ray diffraction pattern of Cu₄(OH)₆SO₄ particles.

FIG. 4A shows plots of potential (vs. Li/Li⁻) versus capacity (mAh/g) for the reaction of Cu₄(OH)₆SO₄ (brochantite) with lithium as described in Example 3. FIG. 4B shows an SEM image of Cu₄(OH)₆SO₄ tapered nanoplates formed as described in Example 3.

FIG. 5A shows charge/discharge curves from five consecutive cycles of the LIB of Example 4. FIGS. 5B and 5C show SEM images of Cu₄(OH)₆SO₄ particles formed as described in Example 4.

FIG. 6A shows charge/discharge curves from five consecutive cycles of the LIB of Example 5. FIGS. 6B and 6C shows SEM images of Cu₄(OH)₆SO₄ nanoplate particles formed as described in Example 5. FIG. 6D shows an X-ray diffraction pattern of Cu₄(OH)₆SO₄ particles formed as described in Example 5. FIGS. 6E and 6F show XRD comparing brochantite prepared using precipitation and hydrothermal synthesis compared to the two polytypes of brochantite as described in Example 6.

FIG. 7A shows voltage profiles of first discharge and charge for half-cells prepared with brochantite made by different methods as described in Example 6. FIG. 7B shows differential charge plots for first two cycles for HT brochantite. FIG. 7C shows cycling of HT brochantite using C/20 rate. The inset shows a zoomed in region in the first discharge. FIG. 7D shows first discharge and charge of sample HT at different C-rates.

FIGS. 8A and 8B show SEM images of HT brochantite film before and after lithtiation, respectively, as described in Example 6. FIG. 8C shows an XRD of the film before and after lithiation.

FIG. 9 show XPS on HT brochanite (A) powder, (B) untested film, (C) after lithiation to 200 mAh/g, (D) after lithiation to 447 mAh/g, and (E) after lithiation to 474 mAh/g followed by delithiation (charge capacity of 343 mAh/g), as described in Example 6.

FIG. 10A shows an SEM image of sodium vanadium jarosite with structure NaV₃(OH)₆(SO₄)₂ prepared as described in Example 7. FIG. 10B shows an X-ray diffraction pattern of sodium vanadium jarosite with structure NaV₃(OH)₆(SO₄)₂. FIG. 10C shows galvanostatic cycling results for sodium vanadium jarosite with structure NaV₃(OH)₆(SO₄)₂ in a Li half cell using a C/20 C-rate (8 mA/g). FIG. 10D shows a differential capacity plot of the first cycle for sodium vanadium jarosite with structure NaV₃(OH)₆(SO₄)₂. FIG. 10E shows a differential capacity plot of the second cycle for sodium vanadium jarosite with structure NaV₃(OH)₆(SO₄)₂.

FIG. 11A shows an SEM image of potassium iron jarosite with structure KFe₃(OH)₆(SO₄)₂ prepared as described in Example 8. FIG. 11B shows an X-ray diffraction pattern of potassium iron jarosite with structure KFe₃(OH)₆(SO₄)₂. FIG. 11C shows galvanostatic cycling results for potassium iron jarosite with structure KFe₃(OH)₆(SO₄)₂ in a Li half cell using a C/20 C-rate (8 mA/g). FIGS. 11D-11H show differential capacity plots for potassium iron jarosite with structure KFe₃(OH)₆(SO₄)₂.

FIG. 12A shows an SEM image of sodium iron jarosite with structure NaFe₃(OH)₆(SO₄)₂ prepared as described in Example 9. FIG. 12B shows an X-ray diffraction pattern of sodium iron jarosite with structure NaFe₃(OH)₆(SO₄)₂. FIG. 12C shows galvanostatic cycling results for sodium iron jarosite with structure NaFe₃(OH)₆(SO₄)₂ in a Li half cell using a C/20 C-rate (8 mA/g). FIGS. 12D-12H show differential capacity plots for sodium iron jarosite with structure NaFe₃(OH)₆(SO₄)₂.

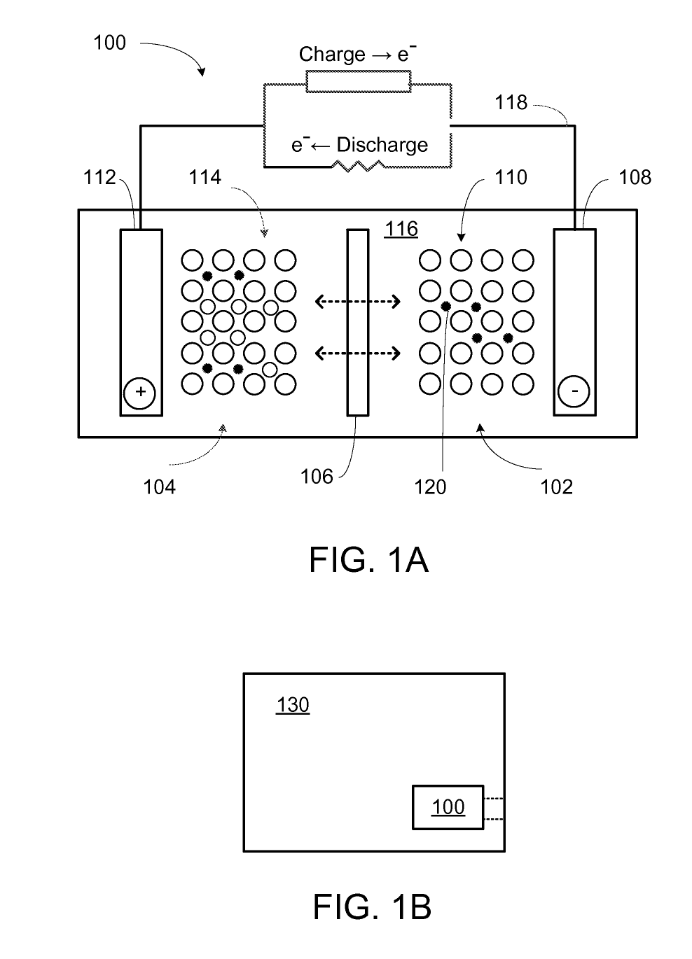

### DETAILED DESCRIPTION

As described herein, lithium-ion battery (LIB) cathodes including transition metal hydroxyl anion materials having the charge-neutral structure Mₓ(OH)ₙ(XO₄)ₘ, in which M is a transition metal (e.g., Cu, Fe, Mn, Ni, V, Co, Zn, Cr, Mo, and solid solutions thereof), x is the total number of transition metal atoms, X is S or P (such that the anion is a hydroxysulfate or hydroxyphosphate), and x, n, and m are integers provide a desired combination of high charge storage capacity and structural stability. These polyanion materials provide an open framework or layered structure with interstitial spaces that can accommodate lithium ions as well as different transition metals, thereby allowing tuning of redox potentials and capacities. Unlike tavorite hydroxyl anion materials, the metal hydroxysulfate and hydroxyphosphate materials including Mₓ(OH)_{y}(XO₄)ₙ are non-tavorite structures, and thus have edge-sharing rather than corner-sharing octahedra.

The selection of related hydroxyanion materials that may be electrochemically active can be guided by the typical redox potentials of transition metals used in cathode materials for LIBs, such as the Cu^{2+/1+}, Fe^{3+/2+}, and Mn^{3+/2+}, V^{4+/3+}, and Co^{3+/2+} redox couples, as well as the existence of stable compositions and structures from mineralogy. Because these materials are based on naturally occurring minerals, the oxidation states of the transition metals are typically in the commonly found +2 valence. For example, there are Mn²⁺ and Ni²⁺ hydroxysulfate analogs to the copper-containing libethenite, cornetite, etc., which may be suitable cathode materials for LIBs under conditions in which the M^{3+/2+} couple is accessible. A lithiated jarosite of the form LiFe₃(OH)₆(SO₄)₂ may be delithiated upon oxidation to Fe⁴⁺. The V³⁻ analog of jarosite is expected to have advantageous electrochemical properties, since the V^{4+/3+} and V^{5+/4+} couples are thought to be electrochemically accessible.

Metal hydroxysulfate and hydroxyphosphate materials of the form Mₓ(OH)_{y}(XO₄)ₙ occur in a variety of expanded frameworks and layered structures Examples include Cu₂(OH)PO₄ (libethenite), Cu₃(OH)₃PO₄ (cornetite) and Cu₅(OH)₄(PO₄)₂ (psuedomalachite), Cu₄(OH)₆SO₄ (brochantite), Cu₃(OH)₄SO₄ (antlerite), Cu₆(OH)₁₀SO₄ (montetrisaite), and sodium iron (III) hydroxyphosphate. The synthesis of hydroxysulfate and hydroxyphosphate materials is facilitated by the fact that the compounds can be precipitated from aqueous solutions of the metal salts or synthesized using hydrothermal methods. For example, the copper hydroxyphosphate libethenite is generally understood to be formed by mixing Cu(NO₃)₂ and (NH₄)₂HPO₄ and precipitating in acidic solutions; the copper hydroxysulfate brochantite are generally understood to be synthesized by refluxing CuCl₂ in NH₄SO₄ and NaOH. Copper hydroxysulfates and hydroxyphosphates can also be obtained by hydrothermal reaction of CuSO₄ in NaOH or H₃PO₄, respectively. The antlerite and brochantite compositions can be obtained by changing the Cu/NaOH/H₂O molar proportions. When these materials are synthesized in nanoparticle form, the resulting nanostructured morphology is believed to improve electrochemical performance due at least in part to the decreased distance required for electronic transport and lithium ion diffusion.

In one example, Cu₂(OH)PO₄, the mineral libethenite, includes PO₄ tetrahedra, CuO₄(OH) trigonal bipyramids, CuO₄(OH)₂ octahedra, and OH groups linking the two Cu species. The structure has chains of edge-sharing CuO₄(OH)₂ octahedra parallel to the c-axis, but no P—O—P chains, which imparts good electronic conductivity. As described herein, Cu₂(OH)PO₄ displays electrochemical activity and can reversibly intercalate Li⁺ ions. The theoretical capacity based on the Cu^{2+/1+} couple is 224 mAh/g, which is significantly higher than the 150 mAh/g observed for LiCoO₂ and LiMn₂O₄ and the 120-170 mAh/g for other polyanion cathodes (e.g., LiFePO₄, LiFeSO₄F). The higher capacity is understood to be due to the presence of two transition metal ions per formula unit, resulting in the 2e⁻ process:

Cu₂(OH)PO₄+2e⁻+2Li⁻→Li₂Cu₂(OH)PO₄.

For reduction of the Cu²⁺ to Cu⁰, as in a conversion reaction, the theoretical capacities (for the 4e⁻ process) would increase to 448 mAh/g. In some cases, lithiated materials having the structure LiₐMₓ(OH)ₙ(XO₄)ₘ as described herein may be synthesized directly.

While libethenite does not contain alkali ions in its initial state, there are other hydroxyphosphate materials that are found in nature already with alkali ions incorporated. For example, sodium iron hydroxyphosphate (SIHP) has a formula Na₃Fe(PO₄)₂.Na₂₍₁₋ₓ₎H₂ₓO, where 0.2<x<0.4. The structure has Fe—O—Fe chains with two phosphates linking adjacent iron atoms. The bridging hydroxyl groups can associate with H⁻ or Na⁺ cations, which are located in the relatively open channels of the phosphate lattice. Thus, this structure has the Fe—O—Fe bonding required for good electronic conductivity, in addition to the Fe—O—X—O—Fe (where X═PO₄) bonding which will promote higher voltages. The open channels may also promote good diffusion of Na⁺ ions.

Hydroxysulfate materials also display interesting structures that may promote high electronic and ionic conductivities. For example, the Cu hydroxysulfate family consists of edge-shared Cu octahedra that form layers. These layered structures may promote the fast insertion/deinsertion of Lit The theoretical capacities for Cu₃(OH)₄SO₄ (antlerite), Cu₄(OH)₆SO₄ (brochantite), and Cu₆(OH)₁₀SO₄ (montetrisaite) for the 3, 4, and 6 electron reduction processes are 227, 237, and 248 mAh/g, respectively. As with the hydroxyphosphates, some iron hydroxysulfates exist already containing alkali metals. For example, solid solutions of the form LiₓK₁₋ₓFe₃(OH)₆(SO₄)₂, similar to the mineral jarosite (XFe₃(OH)₆(SO₄)₂, with X═Na, K, Rb, NH₄, Ag), have been observed.

The selection of related hydroxyanion materials that may be electrochemically active can be guided by the typical redox potentials of transition metals used in cathode materials for LIBs, such as the Cu^{2+/1+}, Fe^{3+/2+} and Mn^{3+/2+}, V^{4+/3+}, and Co^{3+/2+} redox couples, as well as the existence of stable compositions and structures from mineralogy. Because these materials are based on naturally occurring minerals, the oxidation states of the transition metals are typically in the commonly found +2 valence. For example, there are Mn²⁺ and Ni²⁺ hydroxysulfate analogs to the copper-containing libethenite, cornetite, etc., which may be suitable cathode materials for LIBs under conditions in which the M^{3+/2+} couple is accessible. A lithiated jarosite of the form LiFe₃(OH)₆(SO₄)₂ may be delithiated upon oxidation to Fe⁴⁺. The V³ analog of jarosite is expected to have advantageous electrochemical properties, since the V^{4+/3+} and V^{5+/4+} couples are thought to be electrochemically accessible.

These hydroxyanion materials may be made into solid solutions or mixed metal compounds, which can further affect the structural stability and voltage characteristics. For example, Cu²⁺Fe³⁻(OH)(SO₄)₂.4H₂O is known to exist as the mineral guildite, and the solid solution Co₂₋ₓCuₓ(OH)PO₄ has been made synthetically. The presence of multiple transition metals has been shown to modify the structure or improve Li diffusivity in other polyanion systems without being redox active (known as the bystander effect), suggesting that the electrochemical properties of these solid solutions may be tunable to achieve optimal voltage and capacity.

Another attractive feature of polyanion materials is that because the anions are larger than O²⁻, they can be more easily found in a variety of open framework structures that can facilitate the diffusion of Li⁺, and perhaps even larger cations such as Na⁺, Mg²⁺, and Ca²⁻. This may also impart an improved structural stability during cation de-intercalation. However, the heavier weight of the oxyanion lowers the gravimetric capacity, necessitating the use of multi-electron redox processes.

As described herein, hydroxysulfate and hydroxyphosphate materials having edge-sharing (not corner-sharing) octahedra offer a flexible and tunable platform, in terms of composition and structure, having open framework or layered structures with space for lithium ions to intercalate. The structural tunability as well as unique bonding can offer improved electronic and ionic conductivities compared to other polyanion materials, which can affect the charge/discharge rates and power capabilities. Also, the presence of multiple transition metals per formula unit facilitates multi-electron redox reactions, which can lead to high capacity cathode materials.

In one aspect, nanostructured morphology and uniformity of the polyanion material yield higher observed capacities than polyanion material in other morphologies and of lower uniformity. As described herein, “nanostructured morphology” generally includes nanostructures such as nanoparticles, nanocrystals, nanowires, nanofibers, nanorods, nanosheets, nanoplates, and the like.

Nanostructured morphology can be achieved, for example, in a synthesis process that includes the combining a base, a metal salt, and a structure directing agent. Suitable structure directing agents include surfactants (e.g., cetyl trimethylammonium bromide (CTAB), sodium dodecyl sulfate (SDS), sodium dodecylbenzenesulfonate (SDBS), docusate sodium salt, oleic acid, oleylamine, and the like) and polymers (e.g., polyvinylpyrrolidone, polyethylene oxide, polyethylene glycol, polyethyleneimine, polymethyl methacrylate, and the like). The ratio of the number of moles of the metal in the metal salt to the number of moles of structure directing agent can be, for example, between 1:1 and 1:100. Favorable nanostructured morphology has also been achieved via synthesis of polyanion material by a process including microwave-assisted hydrothermal treatment of a composition including a metal salt and a base.

### EXAMPLES

### Example 1

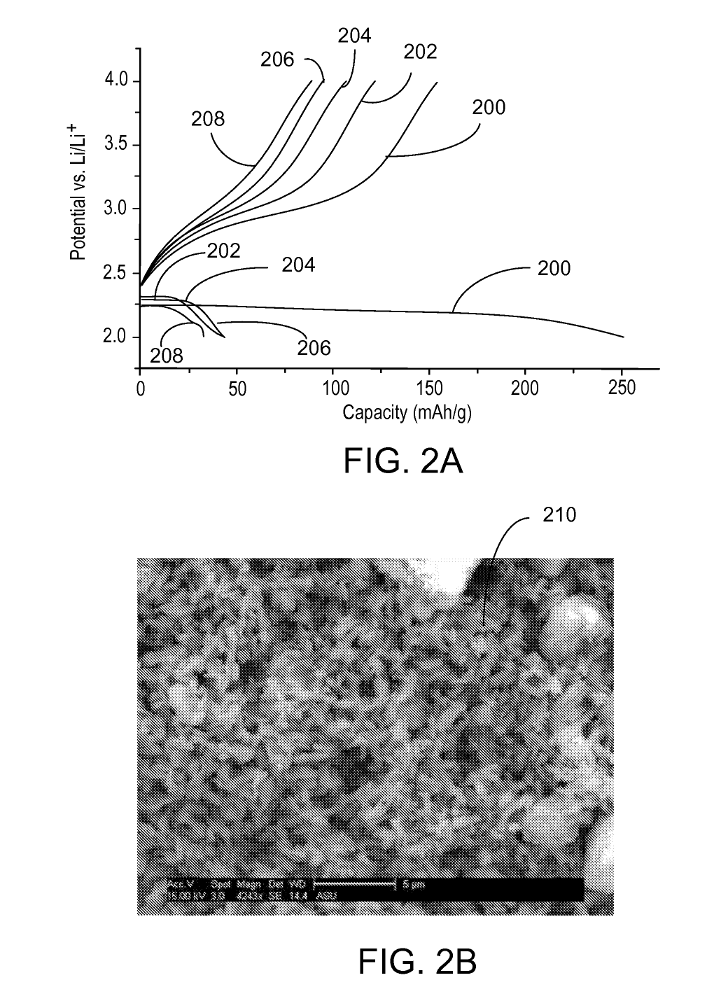

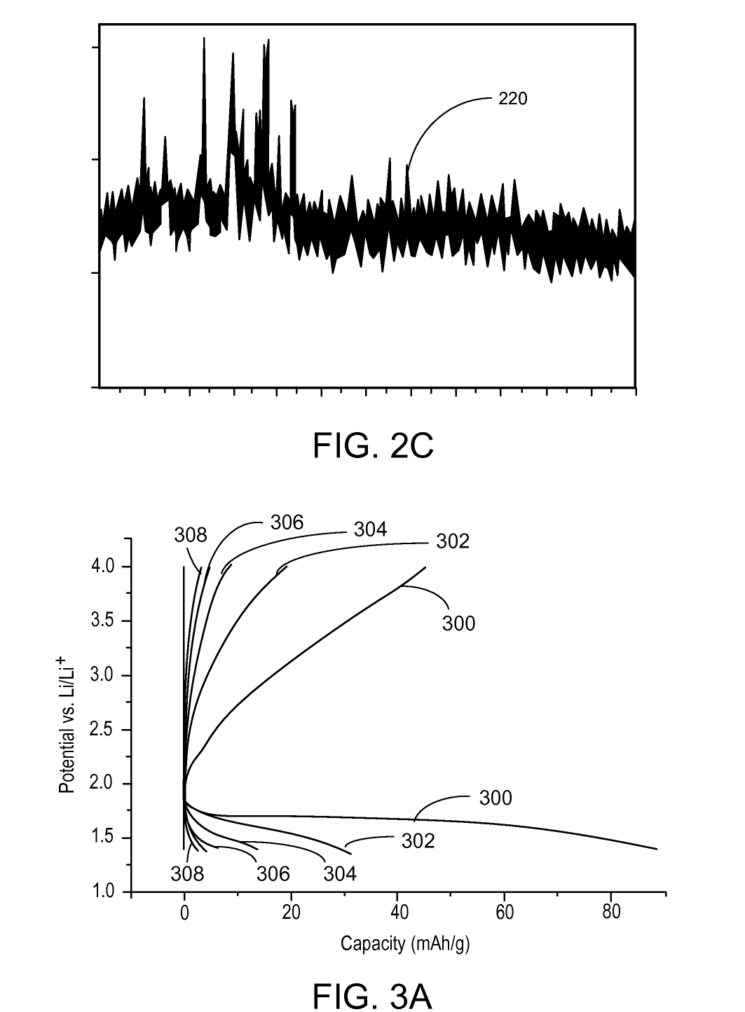

A LIB cathode was prepared by mixing commercially available Cu₂(OH)PO₄ powder (Sigma Aldrich) with 10 wt % carbon black and 10 wt % polyvinylidene difluoride (PVDF) binder in a slurry with N-methyl pyrrolidone as solvent, then coating as a film onto aluminum foil current collectors using a Meyer rod. A LIB was formed with a lithium metal anode and an electrolyte of 1 M LiPF₆ in 1:1 ethylene carbonate: diethylcarbonate. Charge/discharge curves 200, 202, 204, 206, and 208 from five consecutive cycles with the LIB are show in FIG. 2A, with the upper and lower portion of each plot corresponding to charge and discharge curves, respectively. As shown in FIG. 2A, Cu₂(OH)PO₄ was found to be electrochemically active and capable of reversibly intercalating lithium. FIG. 2B is a scanning electron microscope (SEM) image of the Cu₂(OH)PO₄ nanorods 210 used to form the LIB cathode of this example. The nanorods are generally 1-2 μm in length and 100-200 nm in diameter. FIG. 2C shows an X-ray diffraction pattern 220 of the Cu₂(OH)PO₄ nanorods.

### Example 2

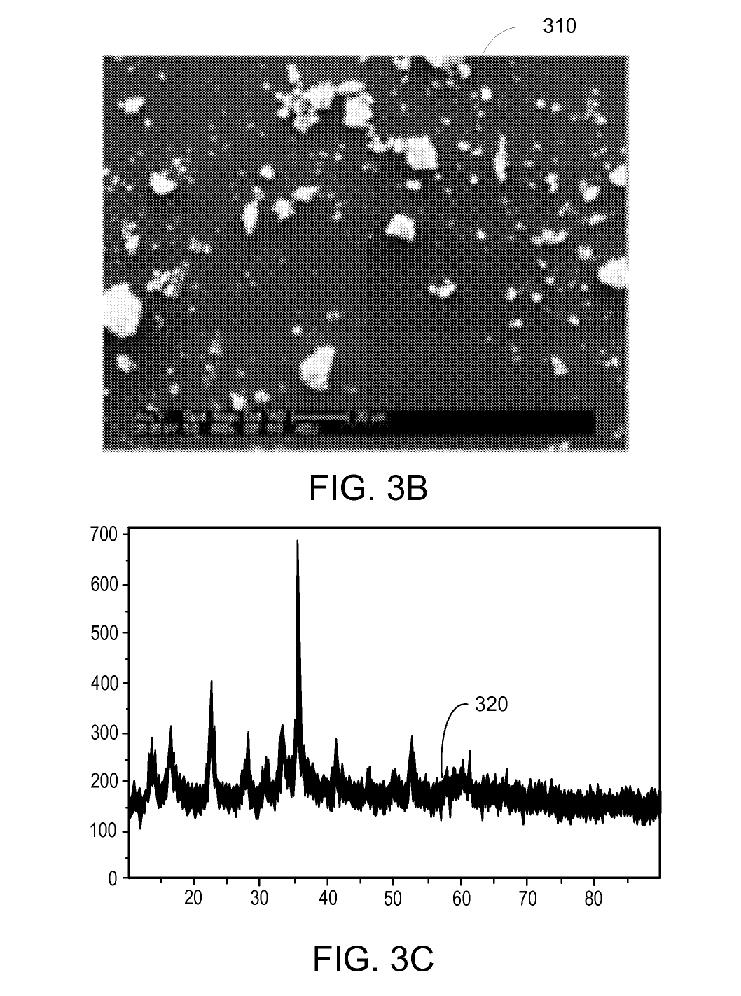

Brochantite was synthesized using titration of 0.1 M NaOH into CuSO₄ of the same concentration, yielding particles in a range of 1-20 μm. A LIB was formed with a lithium metal anode and an electrolyte of 1 M LiPF₆ in 1:1 ethylene carbonate: diethylcarbonate. Charge/discharge curves 300, 302, 304, 306, and 308 from five consecutive cycles with the LIB are show in FIG. 3A, with the upper and lower portion of each plot corresponding to charge and discharge curves, respectively. As shown in FIG. 3A, this material was found to be electrochemically active and capable of reversibly intercalating lithium. The large particle sizes may be responsible for the lower observed capacities than expected theoretically and the capacity fade with subsequent cycling. However, this can be improved through nanostructuring the material as shown in the next examples. FIG. 3B shows an SEM image of the Cu₄(OH)₆SO₄ particles 310 used to form the LIB in this example. FIG. 3C shows an X-ray diffraction pattern 320 of Cu₄(OH)₆SO₄ particles.

### Example 3

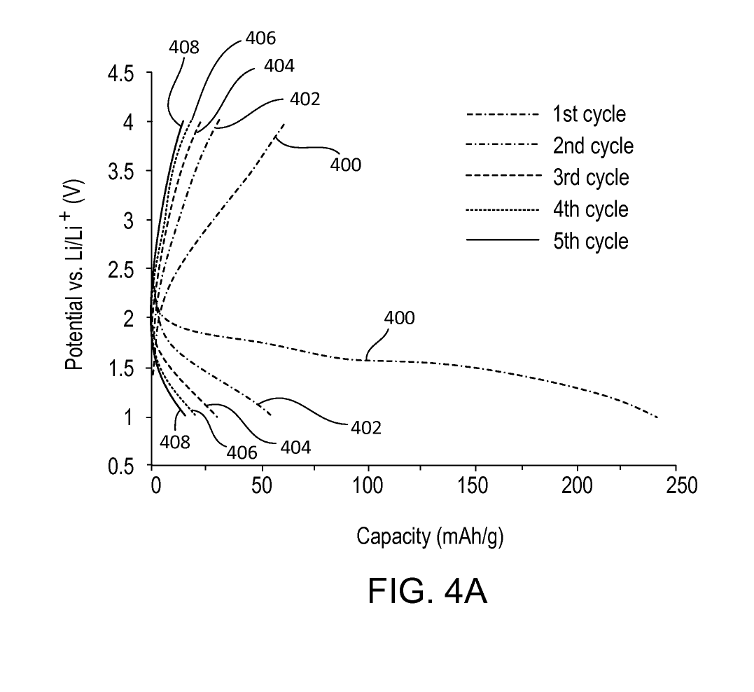

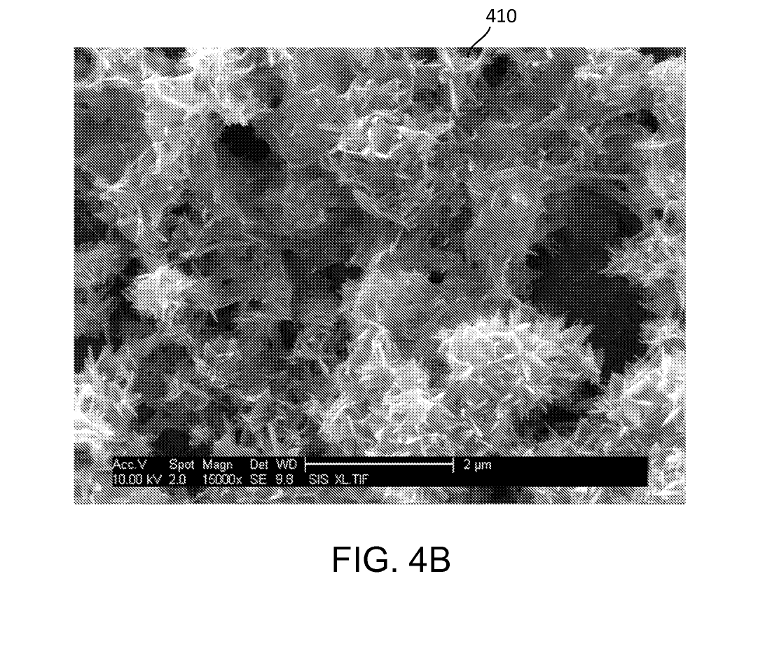

Brochantite was synthesized using titration by adding 0.1 M NaOH with stirring against a solution of copper sulfate of the same concentration containing a Cu²⁺ to polyvinylpyrrolidone (PVP) ratio of n_{Cu2+}:n_{PVP}=1:17.5. The blue-green precipitate was collected, washed and dried at 50° C. overnight. A LIB was formed with a lithium metal anode and an electrolyte of 1 M LiPF6 in 1:1 ethylene carbonate: diethylcarbonate. Charge/discharge curves from five consecutive cycles with the LIB are show in FIG. 4A, with the upper and lower portion of each plot corresponding to charge and discharge curves, respectively. As shown in FIG. 4A, this material was found to be electrochemically active and capable of reversibly intercalating lithium. FIG. 4B shows an SEM image of the Cu₄(OH)₆SO₄ particles used to form the LIB in this example, showing a particle morphology resembling nanoplates assembled into flower or urchin-like structures. The higher observed capacities in this example than that shown in FIG. 3A is believed to be due to the nanostructured morphology.

### Example 4

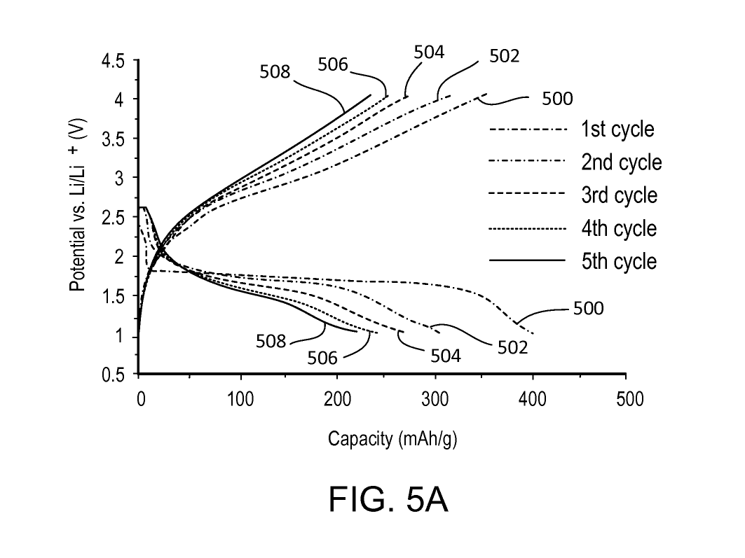

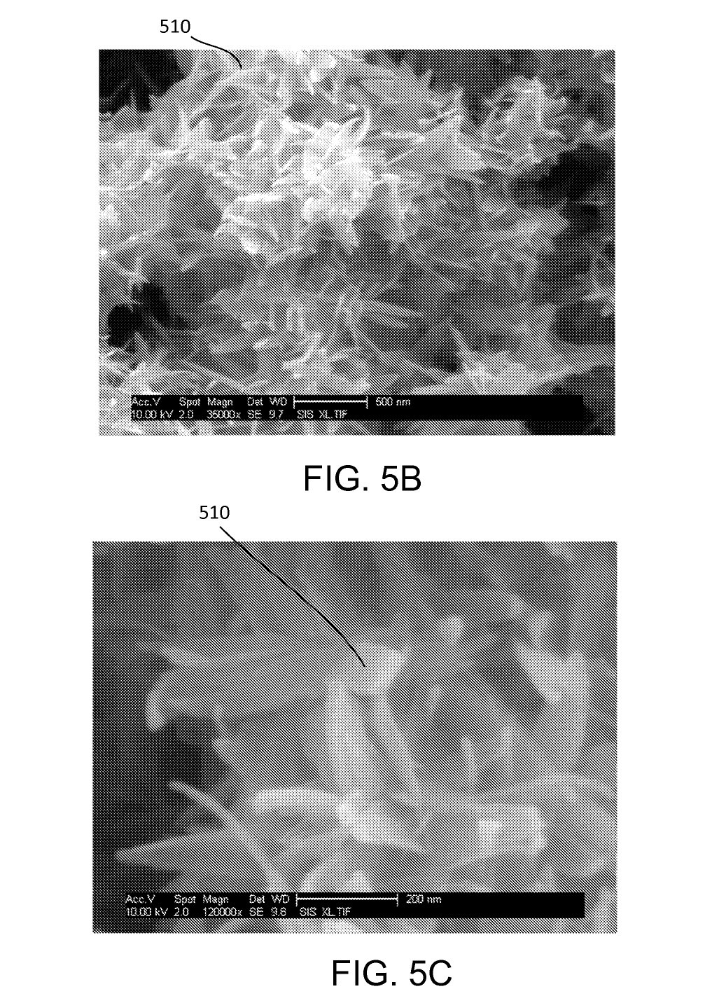

Brochantite was synthesized using titration by adding 0.1 M NaOH with stirring against a solution of copper sulfate of the same concentration containing a Cu²⁺ to polyvinylpyrrolidone (PVP) ratio of n_{Cu2+}:n_{PVP}=1:35. The blue-green precipitate was collected, washed and dried at 50° C. overnight. A LIB was formed with a lithium metal anode and an electrolyte of 1 M LiPF₆ in 1:1 ethylene carbonate: diethylcarbonate. Charge/discharge curves from five consecutive cycles with the LIB are show in FIG. 5A, with the upper and lower portion of each plot corresponding to charge and discharge curves, respectively. As shown in FIG. 5A, this material was found to be electrochemically active and capable of reversibly intercalating lithium. FIG. 5B shows an SEM image of the Cu₄(OH)₆SO₄ particles used to form the LIB in this example, showing a particle morphology resembling nanoplates assembled into flower or urchin-like structures, but with an improved uniformity compared to that shown in FIG. 4B. The higher observed capacities in this example are likely due to the nanostructured morphology and improved particle uniformity.

### Example 5

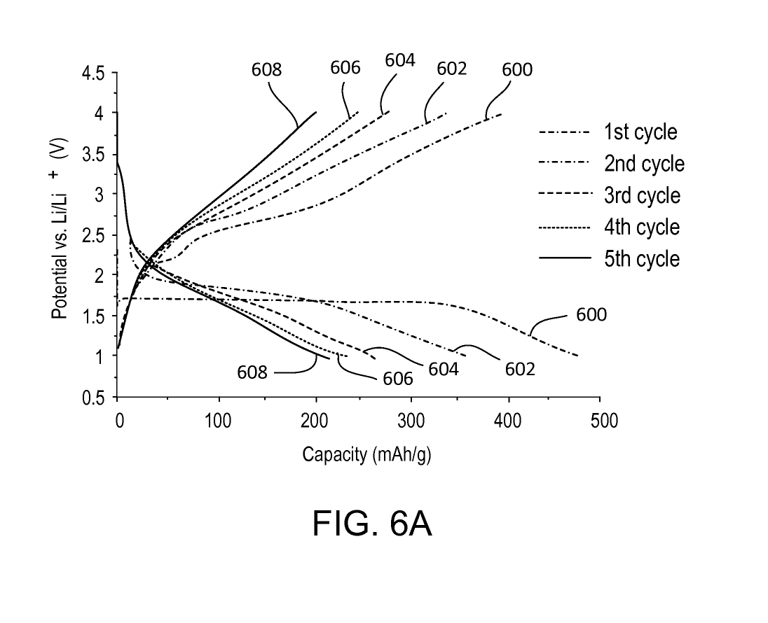

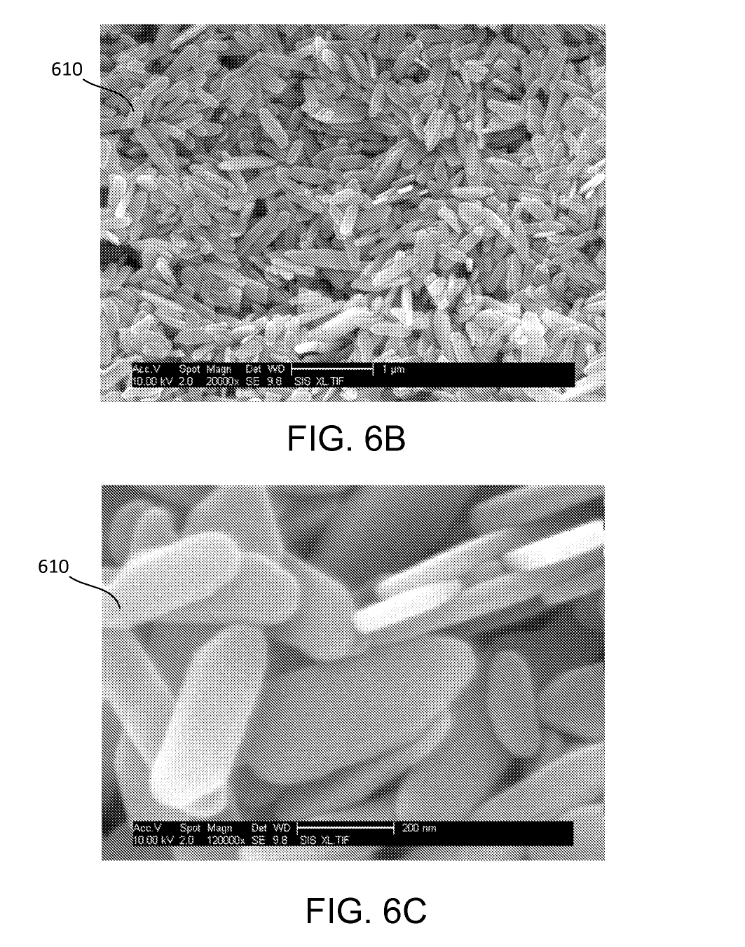

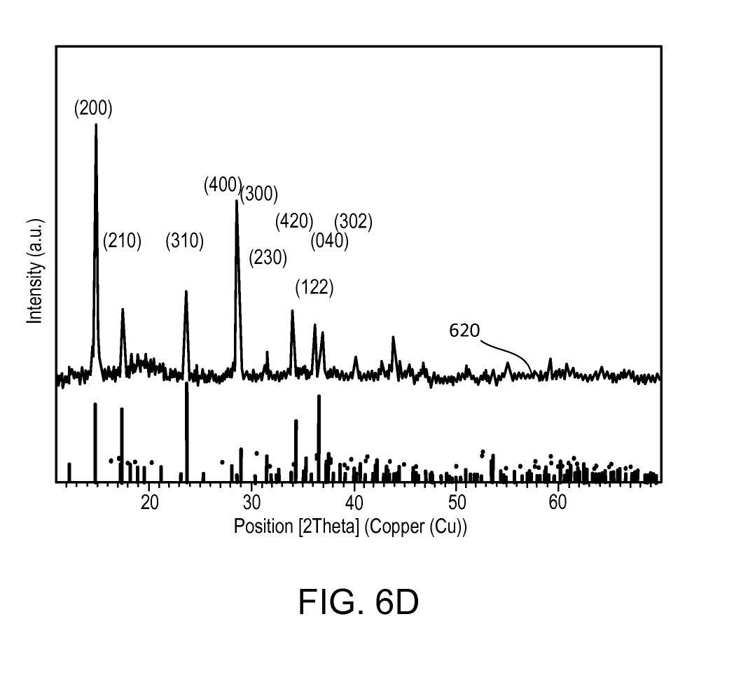

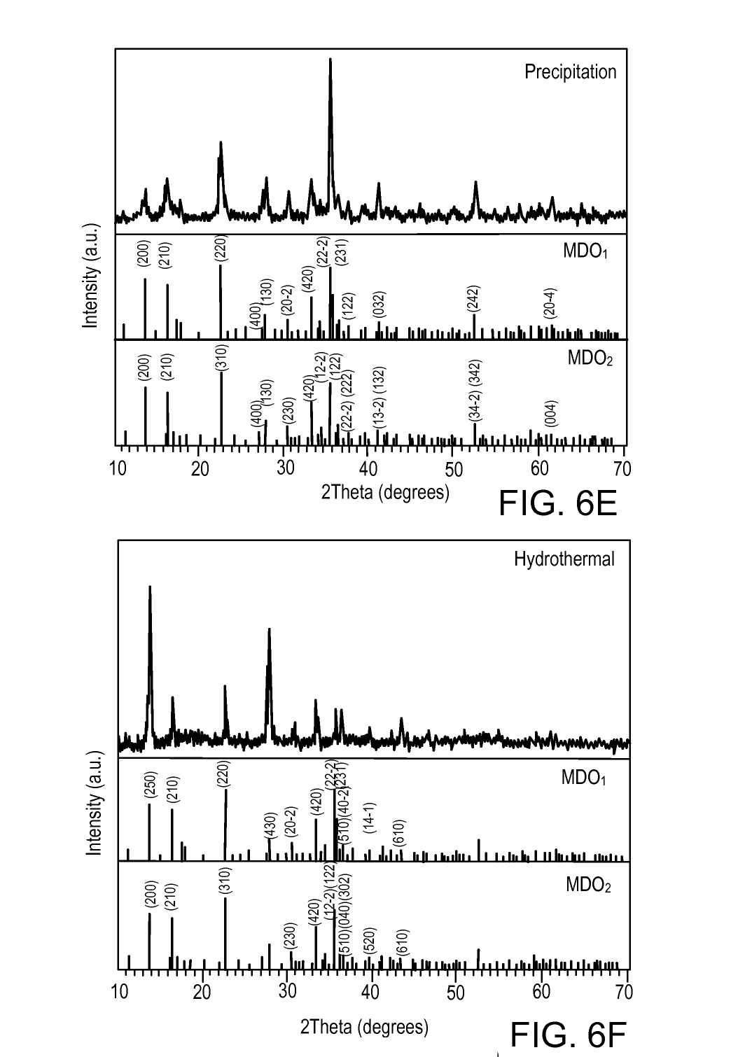

Microwave-assisted hydrothermal treatment was performed on an aqueous suspension of CuSO₄.5H₂O and NaOH in molar proportions of Cu/Na/H₂O=1/1.333/2222 by heating to 170° C. within 10 min and holding for 5 min using a microwave hydrothermal reactor. The blue-green precipitate was collected, washed and dried at 50° C. overnight. A LIB was formed with a lithium metal anode and an electrolyte of 1 M LiPF₆ in 1:1 ethylene carbonate: diethylcarbonate. Charge/discharge curves from five consecutive cycles with the LIB are show in FIG. 6A, with the upper and lower portion of each plot corresponding to charge and discharge curves, respectively. As shown in FIG. 6A, this material was found to be electrochemically active and capable of reversibly intercalating lithium. The morphology of the brochantite powders synthesized using the microwave assisted hydrothermal method is shown in FIG. 6B. These powders had a nanoplate morphology with an average length of 500-400 nm and diameter of about 100-200 nm. FIG. 6C shows an X-ray diffraction pattern of the Cu₄(OH)₆SO₄ particles showing stronger (100) reflections indicating a preferential growth direction. The anisotropic particle morphology observed in the hydrothermal synthesis without requiring PVP or other structure directing agent indicates a preferred crystallographic growth direction.

### Example 6

Brochantite particles were synthesized using precipitation (P) or microwave hydrothermal (HT) techniques as described as follows. After the synthesis, the blue-green powder was collected, washed with ethanol and water several times and dried at 50° C. overnight. Copper(II) sulfate, sodium hydroxide, and polyvinylpyrrolidone (MW=29000) were obtained from Sigma-Aldrich and used as received.

Sample P: 15 mL of 0.1 M NaOH was titrated with stirring into a 15 mL solution of copper sulfate of the same concentration.

Sample P-BM: Sample P was ball-milled for 10 min using a stainless steel grinding vial set.

Sample P-PVP1: 15 mL of 0.1M NaOH was titrated with stirring against a 15 mL solution of copper sulfate of the same concentration containing 0.621 g of polyvinylpyrrolidone (PVP) (n_{Cu2+}:n_{PVP}=70:1).

Sample P-PVP2: 15 mL of 0.1 M NaOH was titrated with stirring against a solution of copper sulfate of the same concentration with 1.243 g PVP (n_{Cu2+}:n_{PVP}=35:1).

Sample HT: Microwave-assisted hydrothermal treatment was performed on an aqueous suspension of CuSO₄.5H₂O and NaOH in molar proportions of Cu/Na/H₂O=1/1.333/2222. The reactions were performed in vessels of volume 33 cm³ with a ⅓ filling ratio. The precursor suspensions were heated to 170° C. within 10 min and were held for 5 min using a CEM Discover SP Reactor.

X-ray diffraction (XRD), scanning electron microscopy (SEM), transmission electron microscopy (TEM), and X-ray photoelectron spectroscopy (XPS) were used to perform structural characterization on the prepared brochantite powders, as well as the composite electrodes before and after cycling. For XRD and XPS, the electrodes were rinsed several times with ethanol and dried at 50° C. overnight. XRD data was collected using a Panalytical X'pert Pro with CuKa irradiation operated at 40 kV/40 mA.

Electron microscopy studies were performed using a XL 30 ESEM-FEG and a JEOL 2010F TEM. Powder samples were dispersed into ethanol with ultrasonication for 5 minutes and then dropped onto a Si wafer for SEM imaging or TEM grid. To mitigate charging, the brochantite samples were sputter coated with a thin layer of Au prior to SEM observation.

XPS was performed on a VG ESCALAB 220i-XL with Al Kα anode (1486.6 eV) operated at 60 W and 12 kV. The X-ray takeoff angle was 45° and the data were acquired from the region within ˜500 μm of the outer surface of the sample. Charge compensation was used because brochantite is an insulator. A pass energy of 20 eV was used for high-resolution spectra (energy resolution 0.7 eV). The spectra were calibrated to the oxygen 2p peak at 531.8 eV instead of the typically used hydrocarbon peaks at 284.5 eV due to many different chemical environments for carbon in the electrodes (e.g. from polyvinylidene difluoride (PVDF), carbon black, dried electrolyte). Peak fitting was performed using CasaXPS processing software.

Brochantite composite electrodes were prepared by mixing the brochantite active material with PVDF binder (Kynar) and SuperP Li carbon black (TimCal) with a ratio of 70:10:20 by weight. N-methyl-2-pyrrolidone was added dropwise and the slurry was then stirred overnight to form a homogenous free-flowing paste. This slurry was then coated onto a piece of Al foil using an automated film coater equipped with a Meyer rod and dried in an oven at 110° C. for 1 h. The foil was then punched into disks and weighed prior to electrochemical testing.

Half cells were assembled in an argon-filed glove box using lithium metal foil as the anode, Celgard 2500 as separator, and 1 M LiPF₆ in EC:DMC (1:1 by vol, MTI) as electrolyte. Galvanostatic or potentiodynamic measurements were performed on a BioLogic VMP3 between 1-4 V vs. Li/Li⁺. For galvanostatic measurements, C-rates were determined using a theoretical capacity of 474.13 mAh/g according to the 2 electron reduction for each of the 4 Cu (insertion of 8 Li⁻) per brochantite formula unit. The current densities corresponding to the C-rates are as follows: C/20 (23.71 mA/g), C/10 (47.41 mA/g), C/5 (94.83 mA/g), C/2 (237.07 mA/g), 1C (474.13 mA/g). For potentiodynamic measurements, a 5 mV voltage step was used with a threshold current of 25 mA/mg of brochantite.

The morphologies of the as-prepared brochantite powders made by the precipitation method were not uniform and ranged from hundreds of nanometers to as large as hundreds of microns. Ball-milling the material decreased the particle size to less than 10 microns. Since the uniformity and range of particle sizes was hard to control, PVP was applied as a structure directing agent at two different molar ratios with respect to the Cu²⁺. PVP was chosen because it is a common polymer used to make shape-controlled nanostructures for many different materials, including brochantite nanorods. Sample P-PVP1 (n_{Cu2+}:n_{PVP}=70:1) consisted of thin plate-like nanostructures, but the sample was not very uniform, as shown in FIG. 5B. Some of the brochantite displayed tapered nanoplate morphology with triangular shaped ends, while other structures displayed hexagonal nanosheet morphology. Increasing the amount of PVP (n_{Cu2+}:n_{PVP}=35:1 for sample P-PVP2) improved the sample uniformity, as shown in FIG. 5C. The sample was composed of tapered nanoplates with approximate dimensions of 100 nm in width, 600 nm in length, and 25 nm in thickness. Brochantite powders synthesized using microwave assisted hydrothermal reaction (sample HT) are shown in FIGS. 6B and 6C. These powders had a nanoplate morphology with an average length of 430 nm and thickness of about 40 nm. Compared to the samples prepared with PVP, the nanostructures in sample HT were thicker and did not have such tapered ends. The plate-like structures observed in samples P-PVP1 and P-PVP2 can be explained by the presence of PVP adsorbing onto certain crystallographic planes of brochantite to affect the crystal growth kinetics. The mechanism of shape control with PVP may be due to Cu²⁺ coordination to the polar oxygen or nitrogen groups of the PVP mers or interaction with the hydroxyl groups on the terminal end of the PVP chains, as has been seen in other nanoparticle systems. The anisotropic particle morphology observed in the hydrothermal synthesis without requiring PVP or other structure directing agent indicates a preferred crystallographic growth direction.

Brochantite is classified as a sheet-type sulfate mineral, with corner-linked and edge-linked chains consisting of distorted Cu(OH)₄O₂ and Cu(OH)₅O octahedra that are connected with SO₄ tetrahedra to form corrugated layers parallel to the (100) plane. Brochantite minerals typically display cleavage on the {100} planes due to the weak apical Cu—O bonds and H-bonds that form between these layers. Planes propagating in the a-direction of brochantite require sulfate ions, while those propagating in the b- and c-directions require hydroxide ions in order to grow the double Cu polyhedra chains. The production and addition rates of these two anions compete and determine the shape of the crystal. Previous studies showed that anisotropic brochantite structures such as plates and needles can be synthesized using ultrasonication, but here we show that use of PVP as a structure directing agent or microwave assisted hydrothermal reaction can result in much smaller nanostructures with high surface area for Li⁺ insertion.

Brochantite is considered an order-disorder (OD) material, in which different ways of stacking neighboring layers allows for disordered and ordered polytypes to exist. FIG. 6E shows the X-ray diffraction (XRD) pattern for sample P, which was prepared using precipitation, and FIG. 6F shows the X-ray diffraction (XRD) pattern for sample HT prepared by microwave-hydrothermal reaction. Only major reflections were labeled for clarity. The precipitated samples prepared with PVP showed identical XRD patterns to sample P. Reference patterns for the MDO₁ and MDO₂ polytypes of brochantite are shown for comparison (Merlino, S. et al., Eur. J. Mineral. 2003, 267-275). Both polytypes are monoclinic and have very similar structures. MDO₁ adopts the P12₁/a1 space group and has lattice constants of a=13.140 Å, b=9.863 Å, c=6.024 Å, and β=103.16°. MDO₂ adopts the P2₁/n11 space group and has lattice parameters of a=12.776 Å, b=9.869 Å, c=6.026 Å, α=90.15°. The XRD pattern for sample P showed reflections that matched both polytypes, which may explain the broadness of some of the peaks. No characteristic diffraction peaks from other phases or impurities were detected. The XRD pattern of sample HT showed sharper and narrower peaks, with enhanced intensity for the (200) and (400) reflections compared to both reference patterns and also the samples prepared with precipitation. Compared to sample P, there were also fewer reflections, while the peaks that were present are common to both polytypes. The absence of reflections in addition to those expected based on the space group (i.e., non-space group absences) has been observed in brochantite and is a characteristics of its OD properties. These results suggest that the microwave-hydrothermal synthesis may favor formation of brochantite with a different atomic connectivity than precipitation methods. The strong (200) and (400) reflections in sample HT indicate a preferred orientation and suggest that the layer-stacking direction, or a-axis, is along the thickness direction of the nanoplates, which tend to lay flat on the substrate, as shown in FIGS. 6B and 6C.

To better understand the structure of the sample HT nanoplates, TEM characterization was performed. Selected-area electron diffraction (SAED) of an individual brochantite nanoplate showed d-spacings consistent with a [100] zone axis for the MDO₁ polytype, with the nanoplate long-axis (growth direction) in the [020] and a-axis along the layer-stacking direction, consistent with the XRD results. However, it has not been ruled out that there might also be nanoplates with the MDO₂ structure.

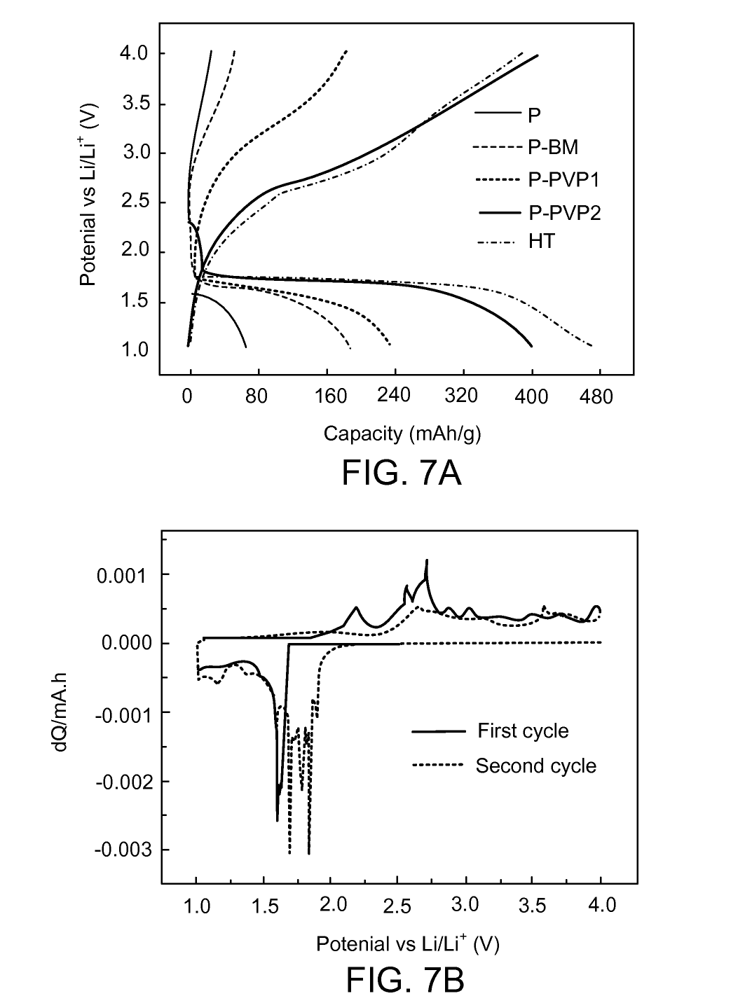

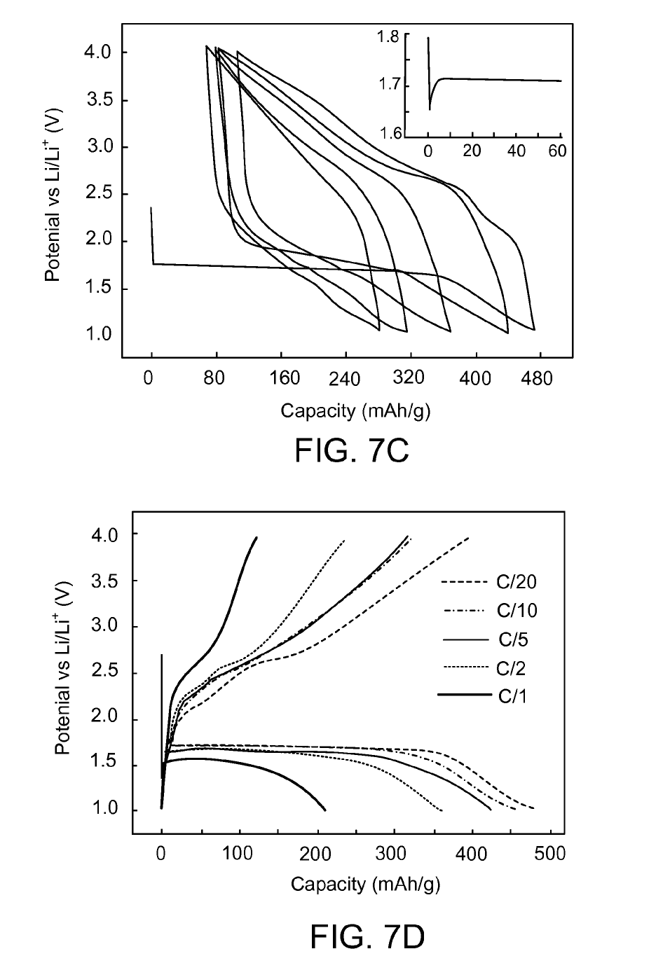

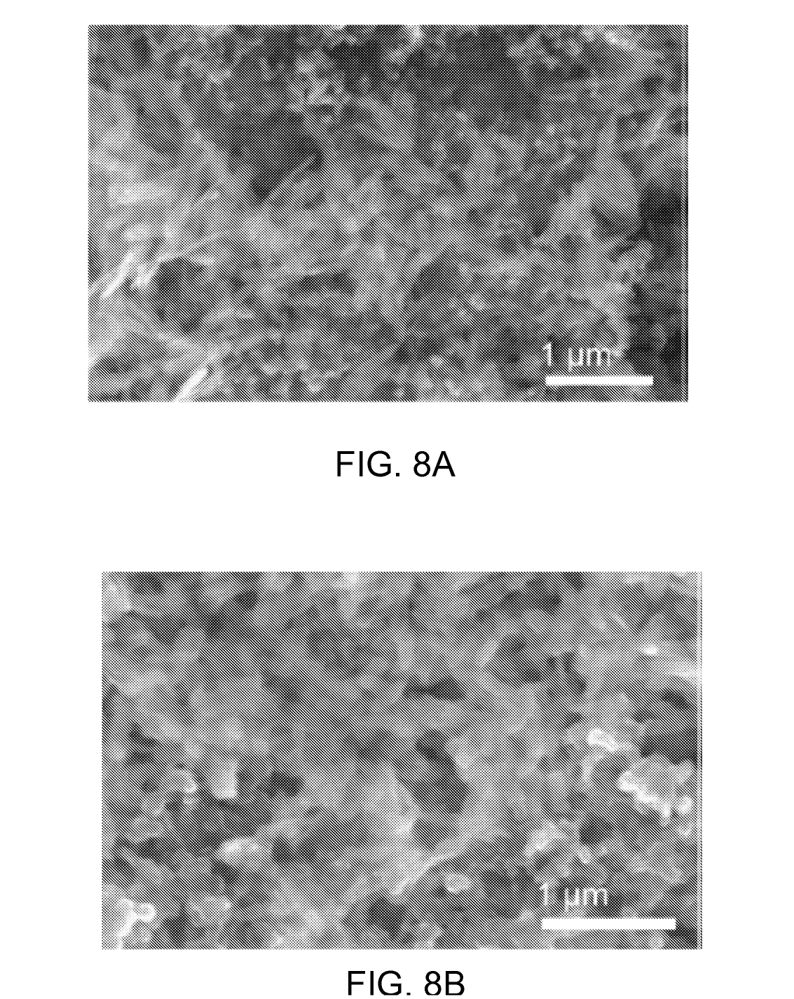

To evaluate the electrochemical properties of the brochantite samples prepared using the various synthesis methods, potentiodynamic cycling was performed on composite electrodes made from brochantite, carbon black conducting additive, and polyvinylidene difluoride binder. The voltage profiles for the first discharge (lithiation) and charge (delithiation) cycles for the different samples are shown in FIG. 7A. The brochantite particles prepared by precipitation (sample P) displayed about 68 mAh/g of discharge capacity and 23 mAh/g of charge capacity, resulting in a Coulombic efficiency (CE) of 34%. After ball-milling the samples for 10 minutes (sample P-BM), the discharge capacity was increased to 191 mAh/g while the CE was about the same (27%), which indicated that decreasing the particle size can help the electrochemical reactivity due to the poor conductivity of the brochantite active material. The precipitated samples prepared with PVP showed even higher capacities and CE, with a discharge capacity of 238 mAh/g for P-PVP1 and 408 mAh/g for P-PVP2. The CE were 78% and 89%, respectively. This indicates that the nanoscale particle sizes can greatly improve the electrochemical performance by decreasing the electron and Li⁺ transport distances. Improvement in reaction kinetics because of the increased active surface area can also contribute to the higher capacities in the nanostructured samples.

The sample HT nanoplates showed the highest discharge capacity of 478 mAh/g, which is slightly higher than the theoretical capacity of 474 mAh/g corresponding to insertion of 8 Li⁻ and electrons per brochantite formula unit, i.e., the 2 electron reduction of Cu²⁺. These results support the conversion reaction mechanism for lithiation of brochantite. The charge capacity of 398 mAh/g corresponds to extraction of 1.68 Li⁺/Cu. Furthermore, the discharge potentials of the nanostructured brochantite were slightly higher than that for bulk brochantite, which can be seen in FIG. 7A. The discharge potential increased from 1.55 V vs. Li/Li⁺ in sample P to 1.6-1.8 V in the PVP samples and 1.7 V for sample HT. The decrease in voltage hysteresis between the discharge and charge with decreased particle size indicate an improvement in the reaction kinetics. The values of the discharge potentials can be explained by the induction effect. For instance, the discharge voltage of brochantite is higher than that for CuO (1.35 V) and Cu₂O (1.5 V) but lower than that for CuSO₄.5H₂O (3.2 V). The discharge voltage for brochantite is slightly higher than that for copper oxides due to the presence of the more ionic sulfate and hydroxyl groups, but its lower number of sulfate anions gives it a lower voltage than for copper sulfate. The plateaus in the discharge profiles suggest a two-phase reaction mechanism, whereby growth of a new phase occurred at the expense of the initial phase, and not a single-phase reaction (i.e., lithiation in the form of solid solution). Also, as the brochantite particle size decreased, the discharge profiles became flatter, which is similar to what has been observed for particle size reduction in CuSO₄.5H₂O and CuO conversion electrodes, indicating improved kinetics. At higher depths of discharge, the voltage followed a sloped profile from 1.5-1 V. This is similar to the sloped profile observed in Cu₂O, which has been attributed to formation of Li₂O and Cu^{0 2}.

In contrast, all of the charging profiles showed sloped features. Inspection of the differential charge plots for the nanostructured brochantite (FIG. 7C) suggests there could be major phase changes at 2.18 and 2.71 V vs. Li/Li⁺ due to the presence of larger peaks at those potentials, there were also numerous small peaks from 2.71 to 4 V vs. Li/Li⁺, suggesting other smaller phase transitions at these higher charging potentials. The electrochemical data are more complicated for the charging of brochantite compared to other similar compounds. Due to the mixed anion nature of brochantite, the electrochemical mechanism for its reaction with lithium may be a combination of reactions similar to those seen in CuO, LiCuO₂, or CuSO₄. This may explain the presence of so many peaks in the differential charge plots. Delithiation occurs as a two-phase reaction at 3.5 V in anhydrous CuSO₄ and at 3.65 V for CuSO₄.5H₂O, with well-defined plateaus at those potentials in the voltage curves. In contrast, the sloped charging profile for brochantite might be more similar to processes in the copper oxides. The initial charging process seen as the sloped region in the voltage profile from 1-2 V is similar to that found when charging Li₂O/CuO composites after full lithiation and has been attributed to the oxidation of Cu⁰ to Cu⁺. The formation of multiple peaks during charging at higher potentials is similar to the delithiation of LiCuO₂, which is characterized by 4 small peaks between 3-3.6 V. The nanoscale size of the brochantite particles may also lead to other phases and reactions not observed in the bulk counterparts, such as small structural changes or solid solution formation over small potential regions.

To better understand the structural changes upon cycling that occur in brochantite, the nanoplates (sample HT) were used for further electrochemical studies as well as ex situ SEM, XRD, and X-ray photoelectron spectroscopy (XPS) investigation. The first 5 cycles of the brochantite nanoplates using galvanostatic cycling with a C/20 rate are shown in FIG. 7C. The potential decreased then increased slightly in the first discharge (FIG. 7C, inset). This feature has been attributed to nucleation and growth of new phases and is frequently seen in materials that undergo conversion reactions. The capacities were observed to decrease quite rapidly, with less than 150 mAh/g capacity remaining at the 10^{th} cycle. The differential charge plot of the second cycle (FIG. 7B), shows that lithiation occurs at higher potentials in the 2^{nd} cycle, suggesting a structural change in the first discharge that is not reversible. Galvanostatic cycling at different C-rates (FIG. 7D) showed that the brochantite could maintain a high first cycle capacity until 1 C, at which the observed capacity was about 50% lower. The second cycles at different C-rates showed similar trends as the first cycles. The nucleation and growth feature was present in the first discharge for all C-rates used, but was more pronounced at the higher currents. For the C/2 and 1C rates, this feature was also present in subsequent discharges, likely because full lithiation was not completed in the first discharge due to the higher rates used.

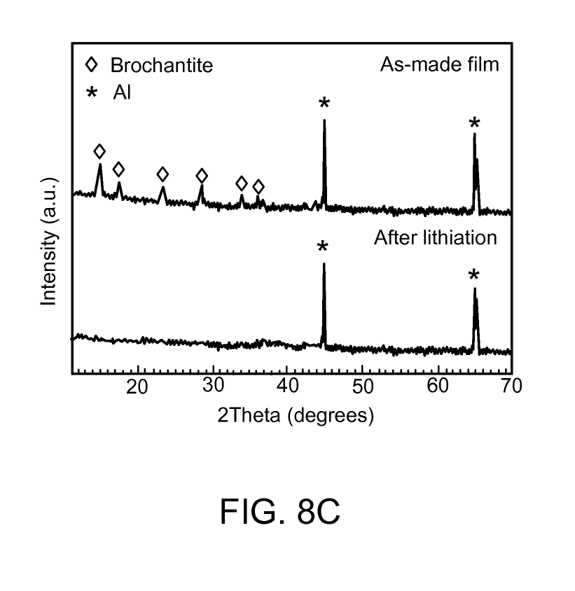

To better understand the origin of the poor capacity retention, SEM, XRD, and XPS studies were performed on the unlithiated (as made), lithiated, and delithiated brochantite films. The brochantite nanoplates were well dispersed with the carbon black (FIG. 8A) in the prepared electrodes and were observed to maintain their morphology after lithiation to 447 mAh/g (FIG. 8B). No obvious signs of Cu metal dendrite extrusion were observed. XRD of the as-prepared film only showed peaks from the Al foil current collector and the brochantite (FIG. 8C). After lithiation to a capacity of 447 mAh/g, the XRD pattern showed very weak reflections from the brochantite, suggesting the structure became amorphous after discharge. This also supports the conversion reaction mechanism, despite the feasibility of topotactic Li⁺ insertion based on the occupiable volume calculations. No obvious peaks from Cu metal, Li₂SO₄ or other Li salts were observed. It is possible that the dispersed nature and small size of these phases make XRD observation difficult unless using high resolution XRD at a synchrotron source, which has been used for investigating discharge products in other Cu containing conversion materials. Although the presence of metallic Cu was not observed in the XRD patterns of discharged brochantite, the full reduction of Cu²⁺ to Cu⁰ is expected based on the high capacities observed. Without more structural characterization, it is difficult to determine what the other discharge products could be. Based on the formula of brochantite, LiOH, Li₂O, and Li₂SO₄ are all reasonable compounds, and they likely form an amorphous matrix.

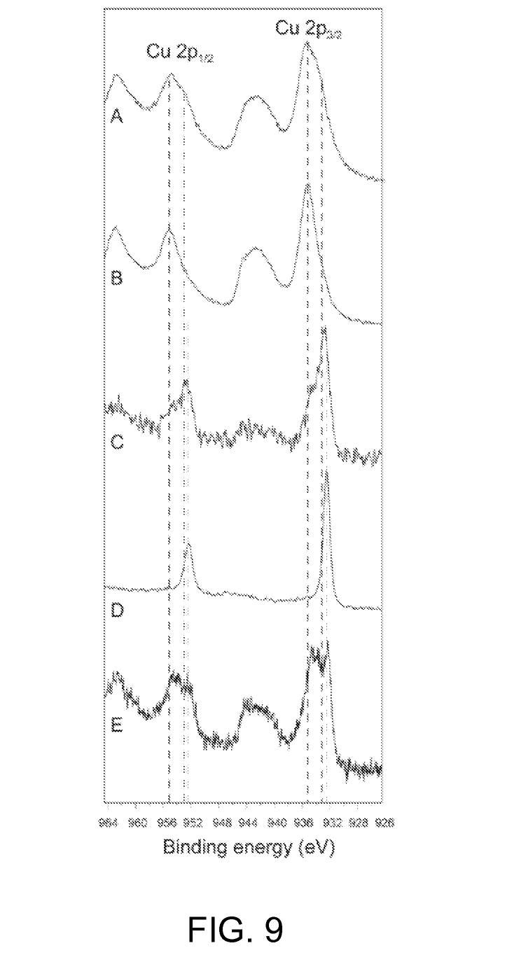

In order to better characterize the oxidation state of the Cu in brochantite during electrochemical reaction, XPS measurements were performed. The instability of LiOH under X-ray irradiation under high vacuum made it difficult to use XPS to better characterize the matrix products. FIG. 9 shows the high resolution scans from the Cu 2p region from different samples to identify the chemical states of the brochantite. Plot A shows the XPS spectrum for the sample HT brochantite powder as a reference. Peaks associated with the Cu 2p_{3/2} and Cu 2p_{1/2} shells were observed along with shake-up satellite bands at higher binding energies to each of the peaks (centered at 942.3 eV for Cu 2p_{3/2} and 962.3 eV for Cu 2p_{1/2}). These satellite peaks are characteristic of Cu²⁺ compounds and arise due to charge transfer transitions from the bound ligands into the unfilled d⁹ valence level of Cu²⁺. The broader Cu 2p peaks in Cu²⁺ containing compounds compared to Cu⁺ and Cu⁰ compounds is due to the coupling between unpaired electrons in the paramagnetic Cu²⁺. The peaks were deconvoluted and could each be fitted to two peaks as noted by the black dotted lines (approximately 935.2 eV and 933.2 eV for Cu 2p_{3/2}, 955.1 eV and 953.0 eV for Cu 2p_{1/2}). Because of the two types of Cu—O bonds in brochantite (i.e., Cu—O—Cu and Cu—O—SO₃), the Cu 2p peaks represent a combination of CuSO₄ (936.0 eV) and CuO (933.1 eV) type contributions, which can also contribute to the broadness of the peaks. The XPS spectrum of the HT brochantite nanoplates is in close agreement to that obtained for naturally occurring brochantite mineral.

In plot B, the XPS spectrum for the HT brochantite electrode (with carbon black and PVDF) prior to electrochemical cycling is shown. Deconvolution of the Cu 2p_{3/2} peaks indicated an increase in peak area for the higher binding energy chemical environment compared to the brochantite powder. Because the XRD pattern of the electrodes showed the brochantite structure did not change after film preparation, this small difference may reflect interactions between the Cu and the fluorides in PVDF.

After the film was lithiated to a capacity of about 200 mAh/g (corresponding to insertion of 0.85 Li⁺/Cu), shoulders appeared at lower binding energies at 932.5 eV for Cu 2p_{3/2} and 952.4 eV for Cu 2p_{1/2}. The intensity of the shake-up bands also decreased significantly. Both of these observations indicate the presence of lower valence species such as Cu⁺ or Cu⁰. Because the binding energies and peak widths for Cu⁺ and Cu⁰ are very similar (932.3 eV for Cu and 932.4 eV for Cu₂O), it is difficult to identify which oxidation state is present. Deconvolution of the Cu 2p_{3/2} peak showed a much lower CuSO₄-type contribution to the chemical environment compared to CuO. The peak attributed to Cu⁺ or Cu⁰ had the highest intensity of the three contributions.

Lithiation of a film to a capacity of 447 mAh/g (1.89 Li⁺ inserted/Cu) resulted in a spectrum as shown in plot D, where the satellite bands completely disappeared and only the Cu 2p peaks associated with Cu⁺ or Cu⁰ remained. Deconvolution of the Cu2p_{3/2} peak showed contributions from three peaks at 931.3 eV, 932.5 eV and 933.5 eV. Since the discharge capacity for the film was 94.3% of the theoretical capacity for brochantite, it is likely that most of the copper is in the form of Cu⁰. Hence, the large peak at 932.5 eV is assigned to Cu⁰. Because of the disappearance of the satellite peaks, the small peak at 933.5 eV may be due to Cu⁺, while the peak at the lowest binding energy may be due to Cu interactions with Li. Since these XPS results suggest that the Cu in the fully discharged brochantite is completely reduced, but no Cu⁰ reflections were observed in the XRD after lithiation (FIG. 8C), this suggests that the Cu must be in the form of very small nanoparticles. Unfortunately, the extreme beam sensitivity of the lithiated brochantite made it difficult for visualization of these particles using TEM.

Plot E shows the XPS spectrum of a brochantite film after one lithiation/delithiation cycle. The presence of Cu²⁺ after charging is apparent due to the large peak at 934.9 eV, which is associated with Cu bonding to sulfate. Other XPS studies on lithiation of CuO and Cu₃B₂O₆ did not observe recovery of Cu²⁺ after charging. In the case of Cu₃B₂O₆, improving the electronic conductivity by adding 65 wt % of carbon in the electrode was effective in improving reversibility and resulted in recovery of the Cu²⁺ peaks after charging. Since the Cu²⁺ peaks were observed in our electrodes with only 20 wt % carbon, this suggests that the nanostructured morphology facilitated good reversibility for the Cu redox reaction, even for a poorly conducting material like brochantite. The discharge capacity observed in this sample was 474 mAh/g and charge capacity was 343 mAh/g, indicating the electrode was almost fully lithiated but during charging the copper was not fully re-oxidized to Cu²⁺. The XPS spectrum is consistent with these results since the peak from Cu⁰ (or Cu⁺) is still present.

Given that the XPS results indicate that the conversion reaction does have some reversibility due to the presence of Cu²⁺ after the electrode was fully lithiated and then charged, the poor capacity retention observed in the brochantite electrodes is likely due to some other reason. Upon disassembly of a cell that was cycled 20 times, the Li metal counter electrode was observed to have some brown coloration. An SEM micrograph and energy dispersive x-ray spectroscopy (EDS) analysis of the Li metal were obtained once removed from the cell Under backscattered electron imaging mode, a phase clearly distinctive from the background was observed. EDS analysis of this region confirmed this phase to be copper metal. Therefore, the poor capacity retention upon extended cycling of the brochantite nanoplates may be due to copper dissolution into the electrolyte and re-deposition on the Li counter electrode. This would result in fewer Cu atoms available in the electrode to participate in the electrochemical reaction and coating of the Li electrode, both of which would affect the cycling performance. The oxidation of Cu⁰ to Cu⁺ species that dissolve in the electrolyte has been observed in other Cu-containing conversion materials.

These results indicate that brochantite can undergo an electrochemical reaction with lithium, with nanostructured morphologies demonstrating the theoretical discharge capacity based on the 2 electron reduction of Cu²⁺. Despite occupiable volume calculations that show topotactic Li⁺ insertion into brochantite might be feasible, we found that brochantite with nanoplate structure underwent a conversion reaction based on XPS results showing formation of Cu⁰ after lithiation. XRD characterization suggested that the discharge products consist of Cu nanoparticles too small to be detected by X-rays within an amorphous matrix. High Coulombic efficiencies indicate that the Cu redox reaction in brochantite nanoplates has high reversibility, unlike other Cu conversion materials such as CuF₂. Long-term capacity retention was limited by Cu dissolution into the electrolyte during charging. The fundamental knowledge gained from this study can be applied to better understanding of the electrochemical properties other mixed anion materials and add to the existing knowledge base related to Cu-based conversion electrodes for lithium-ion batteries. The results indicate that copper hydroxysulfate materials such as brochantite may be promising electrode materials for lithium-ion batteries if this dissolution problem is addressed. Further work on similar materials containing different transition metals may lead to other promising targets with improved cycling performance and higher discharge potentials for use as high capacity cathodes in lithium-ion batteries.

### Example 7

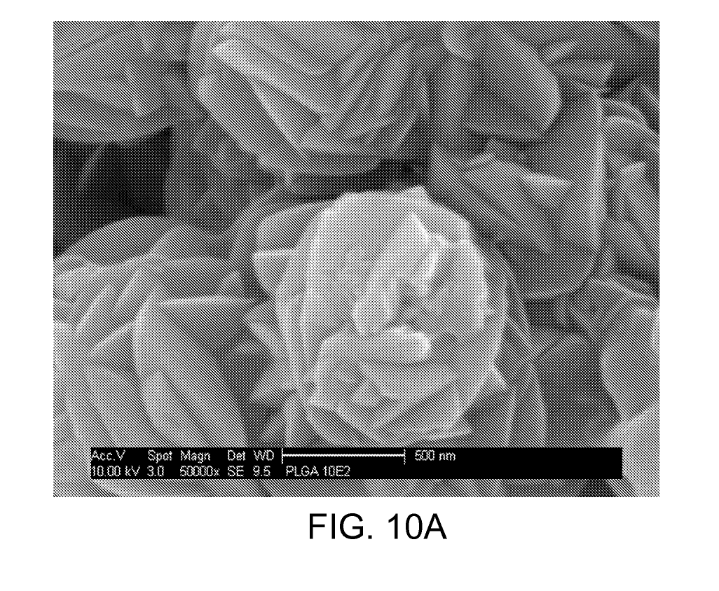

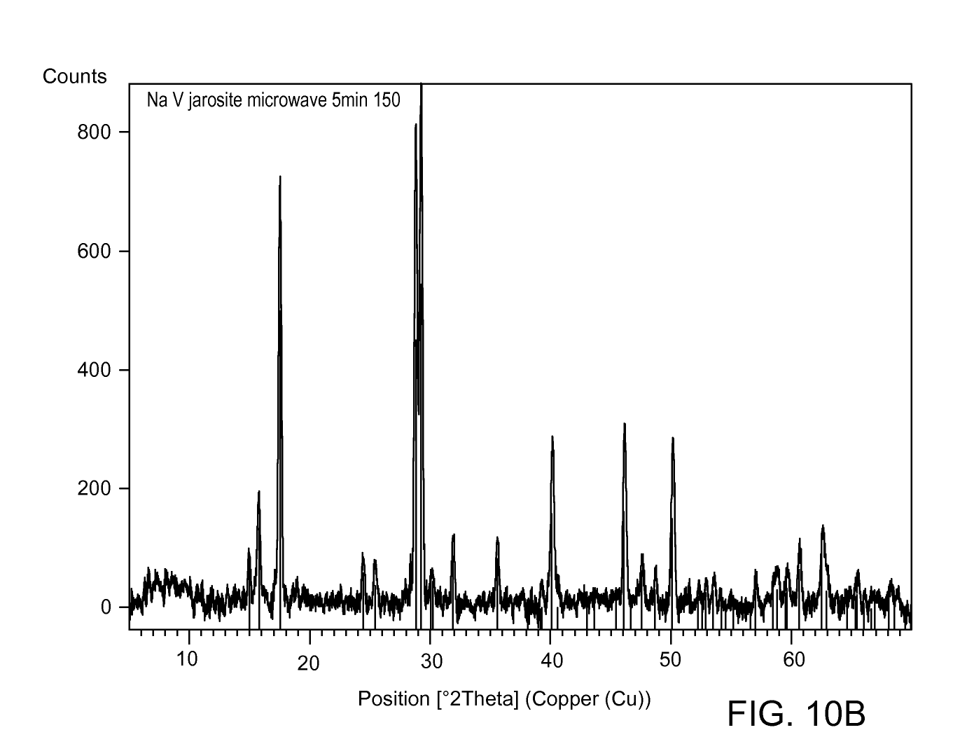

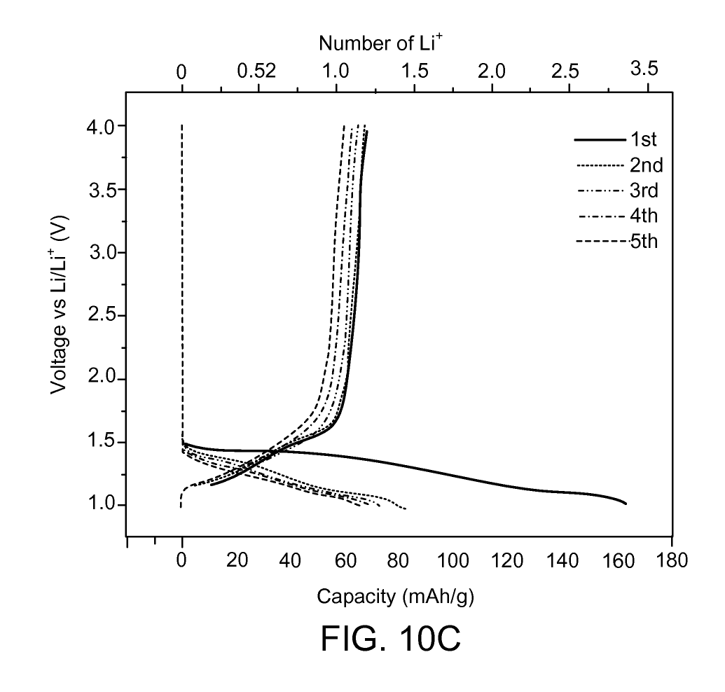

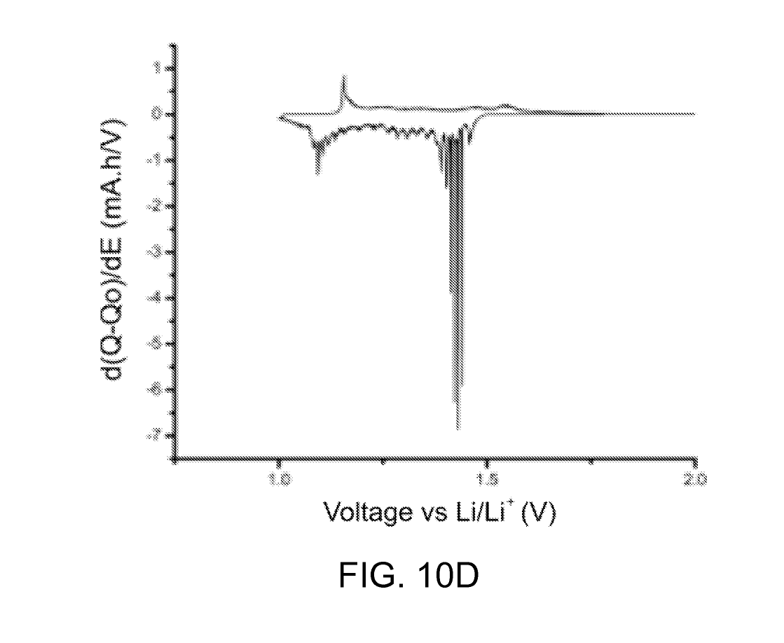

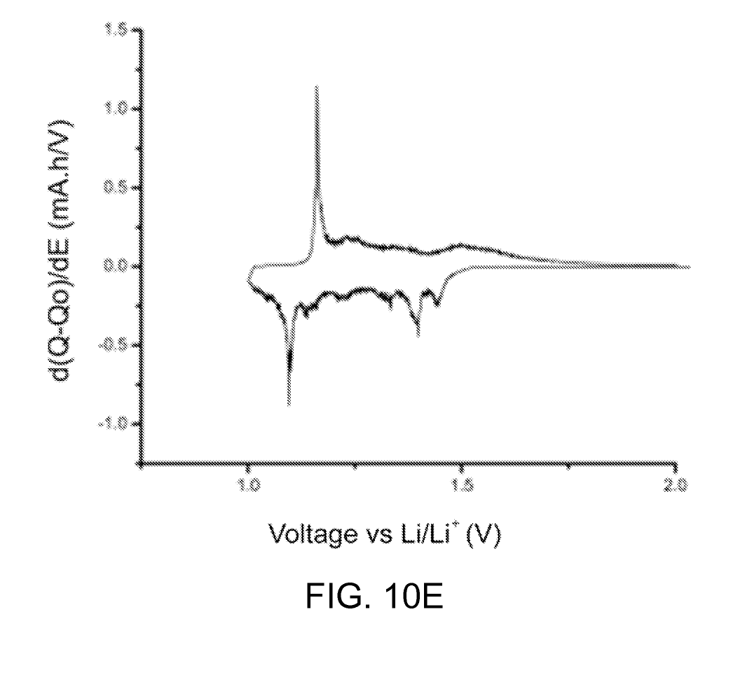

A sodium vanadium jarosite with structure NaV₃(OH)₆(SO₄)₂ was synthesized using a microwave hydrothermal technique. A mixture was prepared from 5 mL of a 0.075 M VCl₃ solution and 5 mL of a 0.15 M Na₂SO₄ solution, which was then transferred to a vessel with volume of 33 mL and sealed. The suspension was heated to 150° C. within 10 min in a microwave hydrothermal reactor and held for 5 min while stirred vigorously. FIG. 10A shows a scanning electron microscope image and FIG. 10B shows the X-ray diffraction pattern of the resulting powders.

Composite electrodes were prepared by mixing the synthetized powder with polyvinylidene difluoride (PVDF) binder (Kynar) and SuperP Li carbon black (TimCal) with a ratio of 80:10:10 by weight. N-methyl-2-pyrrolidone was added drop wise and the slurry was then stirred overnight to form a homogenous free-flowing paste. This slurry was then coated onto a piece of Al foil using an automated film coater equipped with a Meyer rod and dried in an oven at 120° C. for 3 h. The foil was then punched into disks and assembled into a pouch cell with a Li metal anode.

C-rates were determined using a theoretical capacity of 171.07 mAh/g, according to a 1:1 Li:V ratio. Galvanostatic testing using a C/20 C-rate (8 mA/g) and potential limitation between 1 V and 4 V vs. Li/Li⁺ was performed. FIG. 10C shows the results for the first 5 cycles. The first discharge capacity corresponded to 164.31 mAh/g, corresponding to insertion of 2.88 Li per jarosite for formation of Li_{2.88}NaV₃(OH)₆(SO₄)₂. The first charge was 67.88 mAh/g, corresponding to removal of 1.19 Li per jarosite. Subsequent discharges showed reversible insertion of about 1.41 Li per jarosite with a sloped voltage profile between 1.0-1.7 V vs Li/Li⁺. The differential capacity plots showing the Li insertion/deinsertion voltages in the first and second cycle are shown in FIGS. 10D and 10E, respectively.

### Example 8

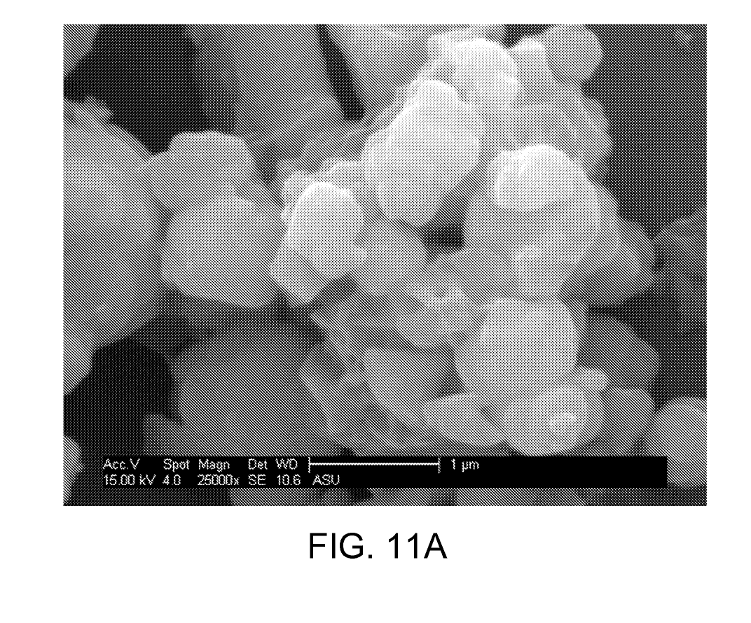

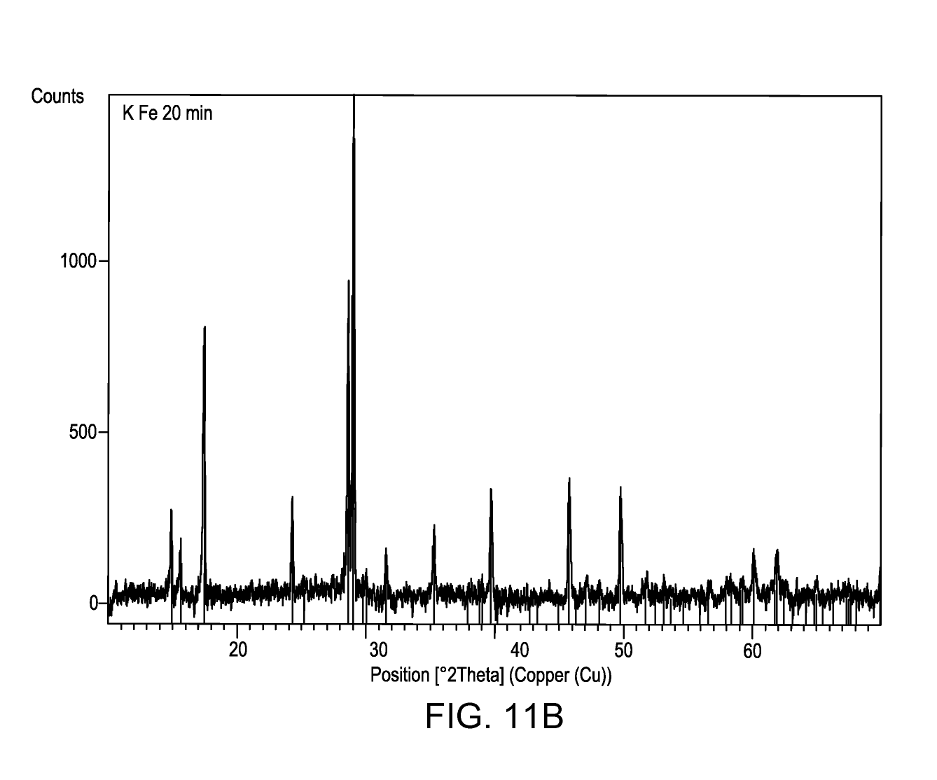

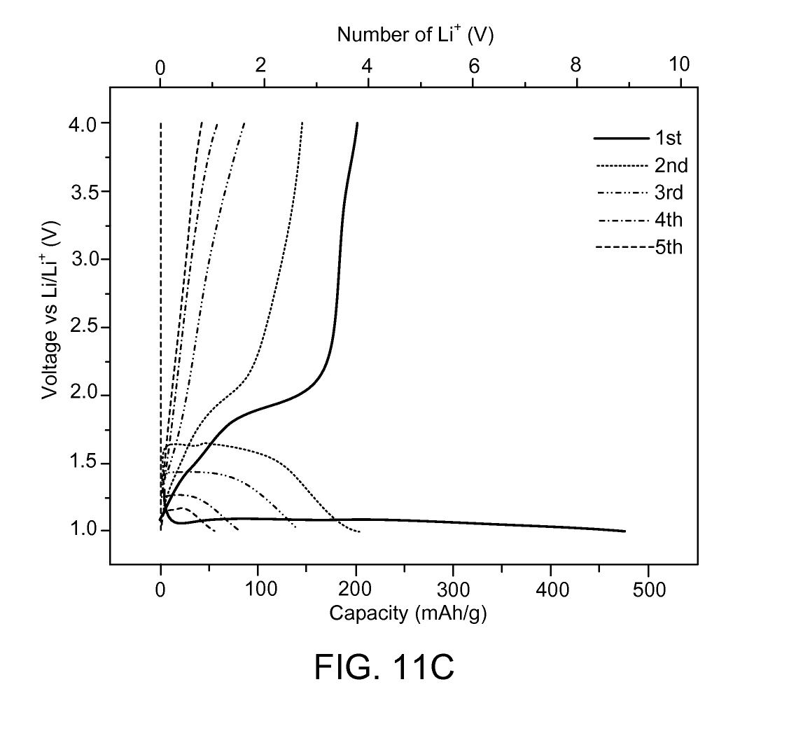

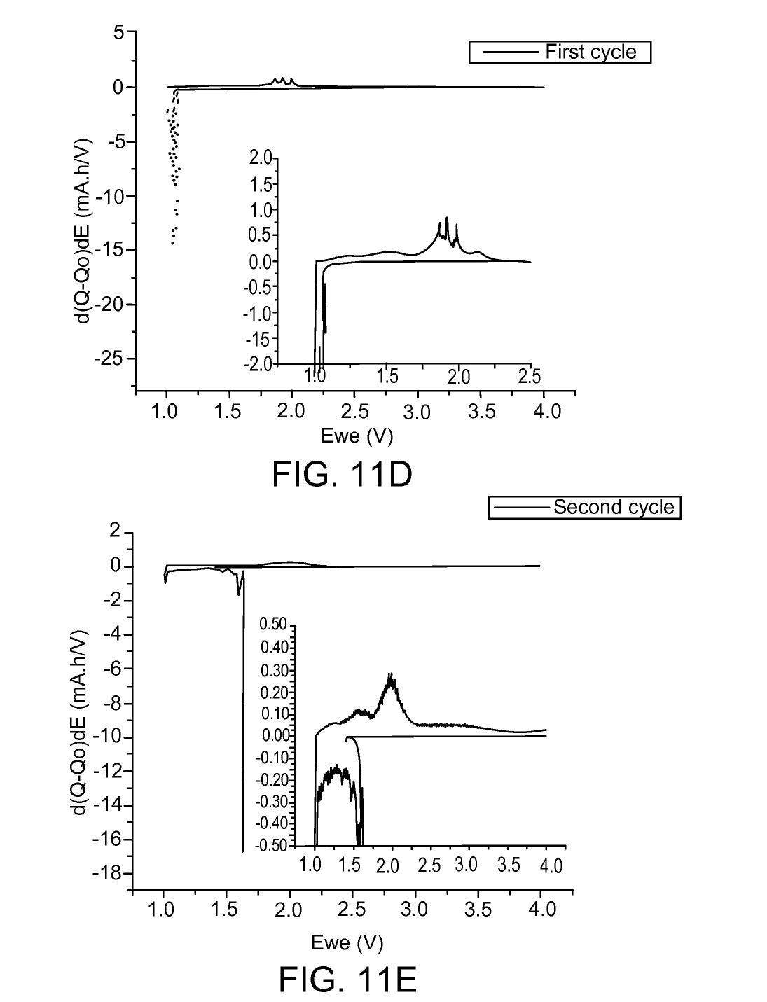

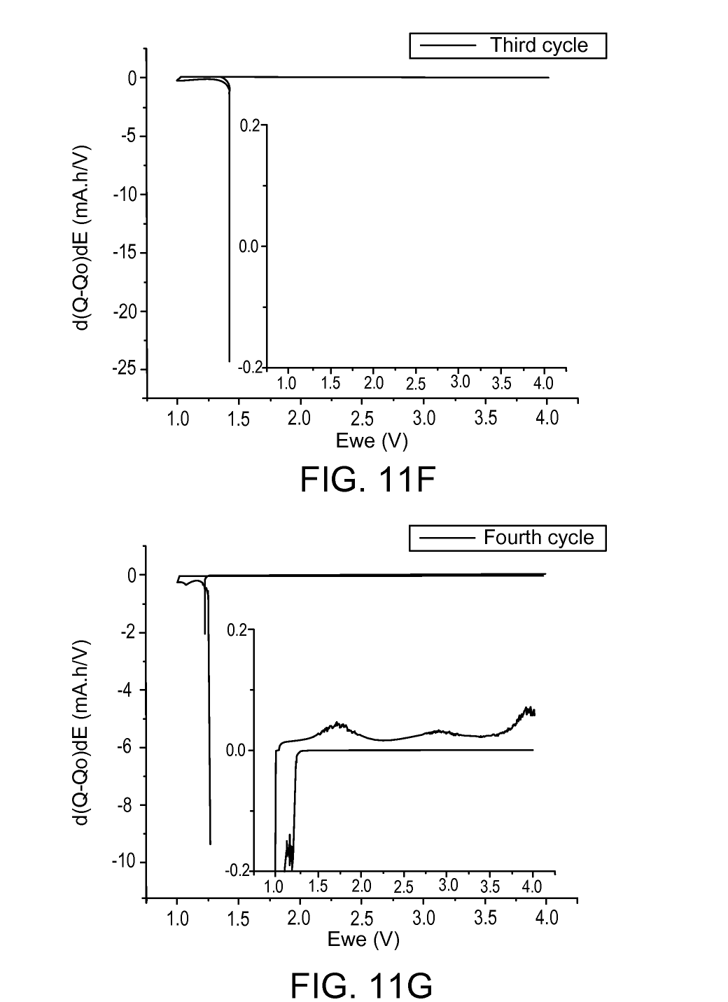

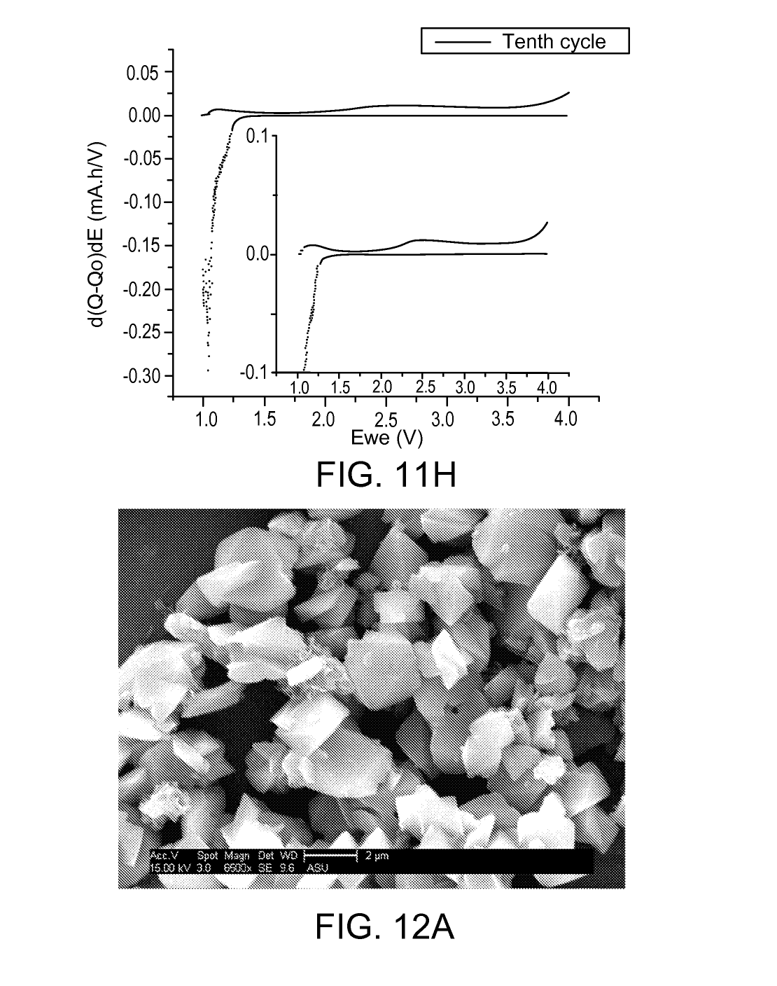

A potassium iron jarosite with structure (KFe₃(OH)₆(SO₄)₂) was synthesized using a microwave hydrothermal technique. A mixture was prepared from 5 mL of a 0.3 M FeCl₃ solution and 5 mL of a 0.6 M K₂SO₄ solution with the pH adjusted to 1.6 with H₂SO₄. The mixture was then transferred to a vessel with volume of 33 mL and sealed. The suspension was heated to 100° C. within 10 min in a microwave hydrothermal reactor and held for 10 min while stirred vigorously. FIG. 11A shows a scanning electron microscope image and FIG. 11B shows the X-ray diffraction pattern of the resulting powders. Composite electrodes and pouch cells were prepared as described in Example 7.

Galvanostatic testing using a C/20 C-rate determined from a theoretical capacity of 160.54 mAh/g was performed with potential limitation between 1 V and 4 V vs. Li/Li⁺. FIG. 11C shows the results for the first 5 cycles. The first discharge capacity corresponded to 476.63 mAh/g, corresponding to insertion of 8.91 Li per jarosite for formation of Li_{8.91}KFe₃(OH)₆(SO₄)₂. The first charge was 200.84 mAh/g, corresponding to removal of 3.75 Li per jarosite. Subsequent cycles showed Li insertion/removal characteristics as follows: 3.83 Li inserted and 2.74 removed in cycle 2, 2.66 Li inserted and 1.61 removed in cycle 3, 1.54 Li inserted and 1.11 removed in cycle 4, 1.06 Li inserted and 0.83 removed in cycle 5, with a sloped voltage profile between 1.0-1.5 V vs Li/Li⁺. The differential capacity plots for the first, second, third, fourth, and tenth difference cycles are shown in FIGS. 11D-11H, respectively, with the Li insertion/removal voltages changes apparent after the second cycle, which may be due to a phase or structural transformation in the jarosite.

### Example 9

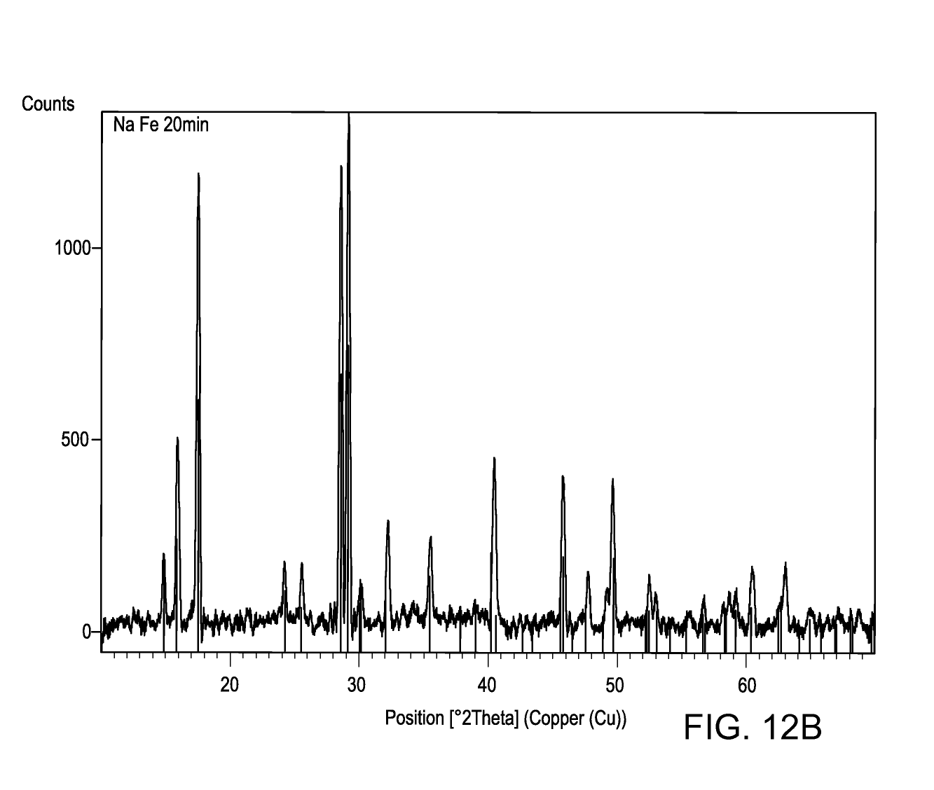

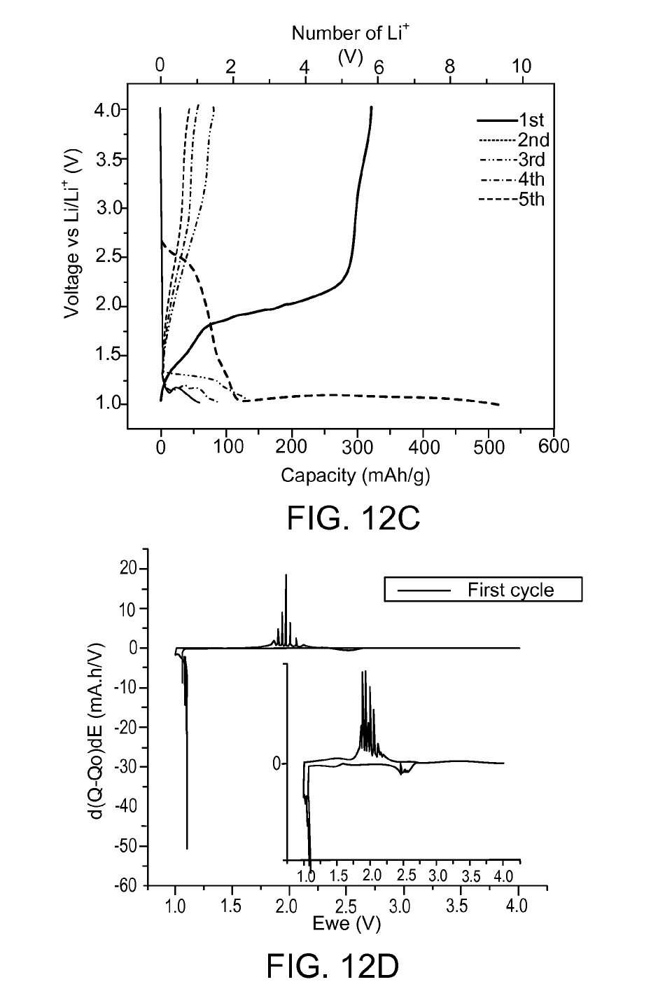

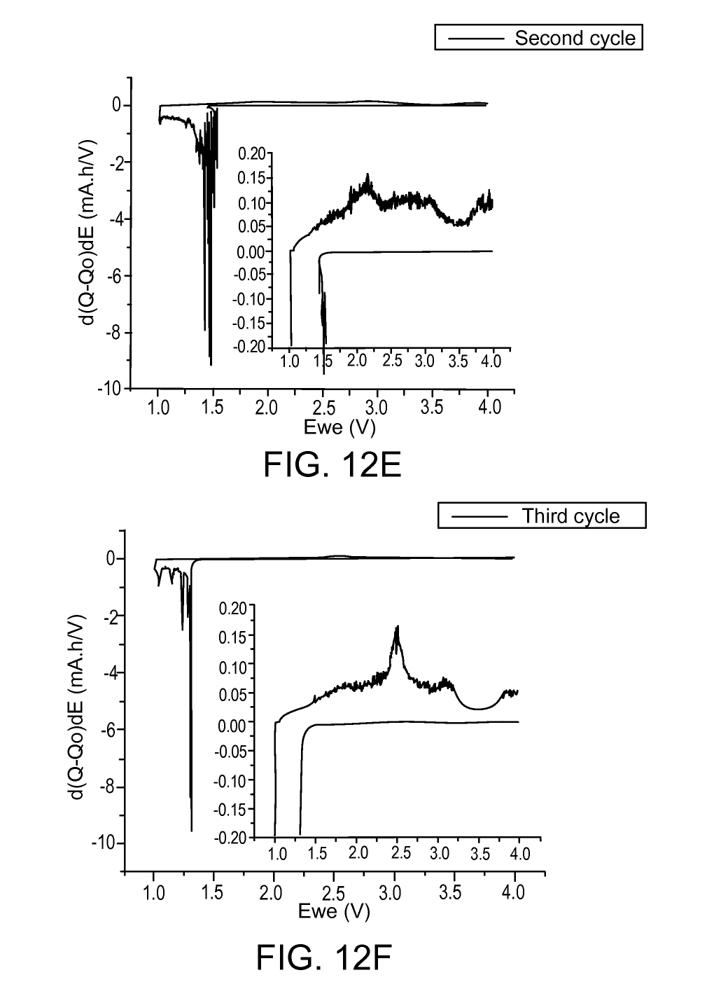

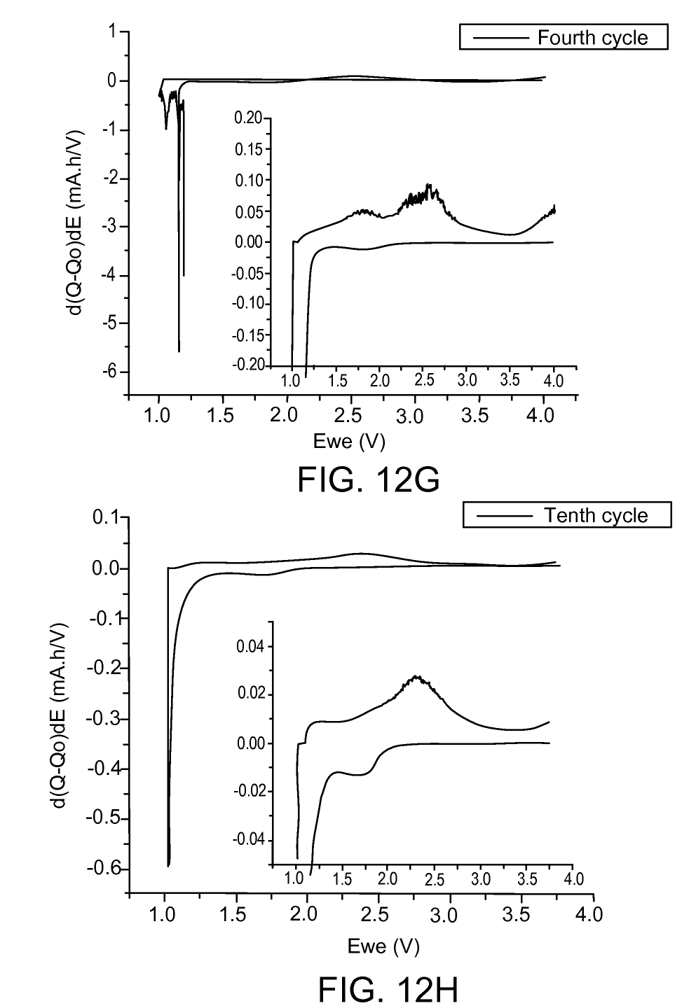

A sodium iron jarosite with structure NaFe₃(OH)₆(SO₄)₂ was synthesized using a microwave hydrothermal technique. A mixture was prepared from 5 mL of a 0.3 M FeCl₃ solution and 5 mL of a 0.6 M Na₂SO₄ solution with the pH adjusted to 1.6 H₂SO₄. The mixture was then transferred to a vessel with volume of 33 mL and sealed. The suspension was heated to 100° C. within 10 min in a microwave hydrothermal reactor and held for 10 min while stirred vigorously. FIG. 12A shows a scanning electron microscope image and FIG. 12B shows the X-ray diffraction pattern of the resulting powders. Composite electrodes and pouch cells were prepared as described in Example 7.

Galvanostatic testing using a C/20 C-rate determined from a theoretical capacity of 165.88 mAh/g and potential limitation between 1 V and 4 V vs. Li/Li was performed. FIG. 12C shows the results for the first 5 cycles. The first discharge capacity corresponded to 516.29 mAh/g, corresponding to insertion of 9.34 Li per jarosite for formation of Li_{9.34}NaFe₃(OH)₆(SO₄)₂. The first charge was 322.95 mAh/g, corresponding to removal of 5.84 Li per jarosite. Subsequent cycles showed Li insertion/removal characteristics as follows: 5.73 Li inserted and 2.34 removed in cycle 2, 2.55 Li inserted and 1.50 removed in cycle 3, 1.66 Li inserted and 1.03 removed in cycle 4, 1.13 Li inserted and 0.80 removed in cycle 5, with a sloped voltage profile between 1.0-1.5 V vs Li/Li The differential capacity plots for the first, second, third, fourth, and tenth difference cycles are shown in FIG. 12D-12H, respectively, with the Li insertion/removal voltages changes apparent after the second cycle, which may be due to a phase or structural transformation in the jarosite.

A number of embodiments of the invention have been described. Nevertheless, it will be understood that various modifications may be made without departing from the spirit and scope of the invention. Accordingly, other embodiments are within the scope of the following claims.

What is claimed is:

1. An electrode for a lithium-ion battery, the electrode comprising a polyanion material including Mₓ(OH)ₙ(XO₄)ₘ, wherein M is one or more transition metals, x is the total number of transition metal atoms, X is sulfur or phosphorus, and x, n, and m are integers, and wherein the polyanion material has a nanostructured morphology.

2. The electrode of claim 1, wherein the electrode comprising the polyanion material is a cathode.

3. The electrode of claim 1, wherein M is selected from the group consisting of copper, iron, manganese, nickel, vanadium, cobalt, zinc, chromium, molybdenum, and any combination thereof.

4. The electrode of claim 3, wherein M is a solid solution of two or more transition metals selected from the group consisting of copper, iron, manganese, nickel, vanadium, cobalt, zinc, chromium, and molybdenum.

5. The electrode of claim 1, wherein M includes at least two transition metals or x is at least 2.

6. The electrode of claim 1, wherein the lithium-ion battery has a capacity of at least 200 mAh/g.

7. The electrode of claim 1, wherein the polyanion material is a hydroxysulfate.

8. The electrode of claim 1, wherein the polyanion material is a hydroxyphosphate.

9. The electrode of claim 1, wherein the polyanion material comprises edge-sharing octahedra.

10. The electrode of claim 1, wherein the polyanion material has a non-tavorite structure.

11. The electrode of claim 1, wherein the polyanion material includes LiₐMₓ(OH)ₙ(XO₄)ₘ, and a is an integer.

12. The electrode of claim 1, wherein the polyanion material is in the form of nanoparticles, nanocrystals, nanowires, nanofibers, nanorods, nanosheets, nanoplates, or a combination thereof.

13. The electrode of claim 1, wherein the polyanion material is synthesized by a process comprising combining a base, a metal salt, and polyvinylpyrrolidone.

14. The electrode of claim 13, wherein the ratio of the number of moles of the metal in the metal salt to the number of moles of polyvinylpyrrolidone is between 1:5 and 1:50.

15. The electrode of claim 13, wherein the polyanion material is synthesized by a process comprising microwave-assisted hydrothermal treatment of a composition comprising a metal salt and a base.

16. A lithium-ion battery comprising the electrode of claim 1.

17. The lithium-ion battery of claim 16, wherein the electrode of claim 1 is a cathode, and further comprising an anode and an electrolyte in contact with the anode and the cathode.

18. A device comprising the lithium-ion battery of claim 16.

19. A method of forming an electrode for a lithium-ion battery, the method comprising:
preparing a composition comprising a polyanion material including Mₓ(OH)ₙ(XO₄)ₘ, wherein M is one or more transition metals, x is the total number of transition metal atoms, X is sulfur or phosphorus, and x, n, and m are integers, and the polyanion material has a nanostructured morphology; and
disposing the composition on a current collector to form the electrode.

20. The method of claim 19, wherein the polyanion material comprises LiₐMₓ(OH)ₙ(XO₄)ₘ, wherein a is an integer.

21. The method of claim 20, wherein M is selected from the group consisting of copper, iron, manganese, nickel, vanadium, cobalt, zinc, chromium, molybdenum, and any combination thereof.

22. The method of claim 21, wherein M is a solid solution of two or more transition metals selected from the group consisting of copper, iron, manganese, nickel, vanadium, cobalt, zinc, chromium, and molybdenum.

23. The method of claim 19, wherein M comprises at least two transition metals or x is at least 2.

24. The method of claim 19, wherein the polyanion material comprises edge-sharing octahedra.

25. The method of claim 19, wherein the polyanion material has a non-tavorite structure.

26. The method of claim 19, wherein the polyanion material is in the form of nanoplates.

27. The method of claim 19, wherein the polyanion material is synthesized by a process including combining a base, a metal salt, and a structure directing agent.

28. The method of claim 27, wherein the ratio of the number of moles of the metal in the metal salt to the number of moles of structure directing agent is between 1:1 and 1:100.

29. The method of claim 28, wherein the structure directing agent comprises a surfactant, a polymer, or a combination thereof.

30. The method of claim 29, wherein the structure directing agent comprises a surfactant selected from the group consisting of cetyl trimethylammonium bromide (CTAB), sodium dodecyl sulfate (SDS), sodium dodecylbenzenesulfonate (SDBS), docusate sodium salt, oleic acid, and oleylamine.

31. The method of claim 29, wherein the structure directing agent comprises a polymer selected from the group consisting of polyvinylpyrrolidone, polyethylene oxide, polyethylene glycol, polyethyleneimine, and polymethyl methacrylate.

32. The method of claim 19, wherein the polyanion material is synthesized by a process including microwave-assisted hydrothermal treatment of a composition comprising a metal salt and a base.

33. An electrode for a lithium-ion battery formed by the method of claim 19.

34. A lithium-ion battery comprising the electrode formed by the method of claim 19.

35. A device comprising the lithium-ion battery of claim 34.
